(19) United States
(12) Patent Application Publication
(10) Pub. No.: US 2017/0249610 A1
(43) Pub. Date: Aug. 31, 2017

(54) SYSTEM AND METHOD FOR PER-VIEWING AND PER-TIMEFRAME COMMERCE

(71) Applicant: Julio FERRER, Oak Park, CA (US)

(72) Inventor: Julio FERRER, Oak Park, CA (US)

(21) Appl. No.: 15/509,078

(22) PCT Filed: Oct. 1, 2015
(86) PCT No.: PCT/US15/53616

§ 371 Date: Mar. 6, 2017

Related U.S. Application Data
(60) Provisional application No. 62/058,100, filed on Oct. 1, 2014.

(51) Int. Cl. G06Q 20/12; G06Q 30/06; H04L 12/58; G06F 3/16; H04N 21/4788; G06F 21/10; G06Q 20/14

(52) U.S. Cl. CPC G06Q 20/1235; G06F 21/105; G06Q 30/0635; G06Q 20/14; G06Q 30/0645; G06Q 30/0643; G06F 3/165; H04N 21/4788; H04L 51/08; G06F 2221/0777; G06F 17/30887

(57) ABSTRACT

A method for per-viewing and per-timeframe commerce includes: creating and transmitting, over a network, by a server-side computing device, a message or packet comprising one or more of user's unique identifier, selected viewing identifier, customization preferences of the user, media content unique identifier, per-viewing identifier, per-timeframe identifier, and sub-account preferences of the user, of one or more of media content and product merchandise, the customization preferences and sub-account preferences of the user obtained by the client device, and customized by the server-side computing device, the per-viewing identifier and per-timeframe identifier, processed by the server-side computing device computing device using one or more of a media content provider's unique identifier and media content database, obtained by a client device, to display tile images associated with the media content unique identifier, and streamed or downloaded, over the network, to a client-side playback device that is substantially synchronized with the server-side computing device.

### PRIORITY CLAIM

The present application claims the priority benefit of U.S. provisional patent application No. 62/058,100 filed Oct. 1, 2014 and entitled “Computer-Readable Medium, System and Method for Per-Viewing and Per-Timeframe Commerce,” the disclosure of which is incorporated herein by reference.

This invention relates to a method and system for one or more purchase, license, rental, distribution and consumption of one or more of one or more of media content and product merchandise via electronic devices. Particularly, the invention relates to a method and system for per-viewing one or more purchase, license, rental, distribution and consumption of one or more of one or more of media content and product merchandise via electronic devices. More particularly, the invention relates to a method and system for one or more per-viewing and per-timeframe one or more purchase, license, rental, distribution and consumption of one or more of one or more of media content and product merchandise via electronic devices. Even more particularly, the invention relates to a method and system for one or more per-viewing and per-timeframe one or more purchase, license, rental, distribution and consumption of one or more of one or more of media content and product merchandise via electronic devices through a communications network. Specifically, the invention relates to a method and system for one or more per-viewing and per-timeframe one or more purchase, license, rental, distribution and consumption of one or more of one or more of media content and product merchandise via electronic devices within and around one or more of a venue, public, office and home environment through a communications network.

According to embodiments of the invention, a platform is provided for one or more per-viewing and per-timeframe one or more purchase, license, rental, distribution and consumption of one or more of audio content, video content, media content, and other data during playback of content. For example, the content may be digital content. For example, the content may be another type of content other than digital content. For example, the content may be accessed by a user using a client device. For example, the content may be accessed by the user over a network. For example, the content may be accessed by sub-account of the user. For example, the content may be accessed by one or more of the user and sub-account of the user. For example, the content may comprise customized content. For example, the audio content may comprise customized audio content. For example, the audio content may comprise one or more customized audio content and an other audio content. For example, the video content may comprise customized video content, For example, the video content may comprise one or more customized video content and an other video content. For example, the customized content may comprise that which is described in United States application Number or PCT International Application Number filed Aug. 13, 2015 entitled “System and Method for Real-Time Customization and Synchronization of Media Content”, with priority benefit of U.S. provisional patent application No. 62/036,834 filed Aug. 13, 2014 and entitled “Computer-Readable Medium, System and Method for Real-Time Customization and Synchronization of Media Content”, which are hereby incorporated by reference in their entirety.

According to further embodiments of the invention, a platform is provided for one or more purchase, license, rental, distribution and consumption of product merchandise. For example, product merchandise may be physical goods. For example, product merchandise may be services. For example, product merchandise may be media content. For example, product merchandise may be another type of merchandise other than physical goods, services and media content. For example, product merchandise may comprise customized product merchandise. For example, customized product merchandise may comprise customized audio content. For example, product merchandise may comprise customized video content. For example, product merchandise may comprise of one or more customized audio and customized video content. For example, product merchandise may be accessed by the user using a client device. For example, product merchandise may be accessed by the user over a network. For example, product merchandise may be accessed by sub-account of the user. For example, product merchandise may be accessed by one or more of the user and sub-account of the user. For example, product merchandise may be exclusively available in one or more specific venue, public, office, school and home environment. For example, product merchandise may be non-exclusively available in one or more specific venue, public, office, school and home environment. For example, product merchandise may be made available for a limited time interval only. For example, product merchandise may be made available for an other time interval.

According to still further embodiments of the invention, a platform is provided for one or more purchase, license, rental, distribution and consumption of media content and product merchandise on one or more of a per-viewing and per-timeframe basis. For example, per-viewing may comprise one or more purchase, license, rental, distribution and consumption for one viewing of media content by the user. For example, per-viewing may comprise one or more purchase, license, rental, distribution and consumption for multiple viewings of media content by the user. For example, per-timeframe may comprise one or more purchase, license, rental, distribution and consumption of media content for twenty-four hours by the user. For example, per-timeframe may comprise one or more purchase, license, rental, distribution and consumption of media content for several weeks by the user. For example, per-timeframe may comprise one or more purchase, license, rental, distribution and consumption of media content for an other time interval other than twenty-four hours or several weeks by the user. For example, one or more purchase, license, rental, distribution and consumption of media content may comprise an other basis for viewing media content by the user. For example, one or more purchase, license, rental, distribution and consumption may comprise limiting media content availability to the user to that of a particular rating and other factors. For example, a rating of the media content comprises one or more of a rating by the Motion Picture Association of America, a violence content advisory level, a TV Parental Guideline, a sexual content advisory, and an other rating of the media content. For example, other factors may comprise one or more of user's account information, time zone, regional language usage, and other factors.

According to other embodiments of the invention, a method for per-viewing and per-timeframe purchase, license, rental, distribution and consumption of media content and product merchandise includes: obtaining and processing, by a client device under a user's control, a user's username and password by the user; creating and transmitting, by the client device, to a server-side computing device, a client-side message or packet comprising one or more of user's username and password; receiving and processing, by the client device, a server-side message or packet comprising one or more of user's unique identifier, customization preferences of the user, media content unique identifier, media image URLs, media content URLs, and sub-account preferences of the user for media content to be played on the client device in coordination with the server-computing device; obtaining and processing, by the client device, a command to display media content by the user; creating and transmitting, by the client device, to the server-side computing device, a client-side message or packet comprising one or more user's unique identifier and media content unique identifier of the media content selected by the user; receiving and processing, by a client device, a server-side message or packet comprising one or more of user's unique identifier, customization preferences of the user, media content unique identifier, media images URLs, media content URLs, per-viewing identifier, per-timeframe identifier, and sub-account preferences of the user of the media content selected by the user; and creating and displaying display tile images using the media content unique identifier for the client-side playback of the media content selected by the user.

According to further embodiments of the invention, a method for per-viewing and per-timeframe purchase, license, rental, distribution and consumption of media content and product merchandise includes: receiving and processing, by a server-side computing device, from a client device under a user's control, a client-side message or packet comprising one or more of a user's username and password; creating, by the server-side computing device, a server-side message or packet comprising one or more of a user's unique identifier, customization preferences of the user, media content unique identifier, media images URLs, media content URLs, and sub-account preferences of the user; transmitting, by the server-side computing device, to the client device, the server-side message or packet comprising one or more of user's unique identifier, customization preferences of the user, media content unique identifier, media images URLs, media content URLs, and sub-account preferences of the user; receiving and processing, by the server-side computing device, a client-side message or packet comprising one or more of user's unique identifier and media content unique identifier; processing, by the server-side computing device, records comprised in one or more of first data storage, second data storage, server-side data storage and server-side memory so as to create per-viewing time allowance and per-timeframe allowance of media content; and generating and transmitting, by the client device, the server-side message or packet comprising one or more of user's unique identifier, customization preferences of the user, media content unique identifier, media images URLs, media content URLs, per-viewing identifier, per-timeframe identifier, and sub-account preferences of the user.

According to still further other embodiments of the invention, a method for viewing per-viewing and per-timeframe purchase, license, rental, distribution and consumption of media content and product merchandise includes: obtaining and processing, by a client device under a user's control, a selection for viewing media content by the user; displaying and processing, by the client device, a confirmation prompt of the selection for viewing media content; generating and transmitting, by the client device, to a server-side computing device, a client-side message or packet comprising one or more of user's unique identifier and selected viewing identifier; receiving and processing, by the client device, a server-side message or packet comprising one or more of user's unique identifier, selected viewing identifier, customization preferences of the user, media content unique identifier, media image URLs, media image URLs, per-viewing identifier, per-timeframe identifier, and sub-account preferences of the user; and obtaining and processing, by the client device, a command to commence playback of the media content by the user.

According to yet further other embodiments of the invention, a method for viewing per-viewing and per-timeframe purchase, license, rental, distribution and consumption of media content and product merchandise includes: receiving and processing, by a server-side computing device, from a client-device under a user's control, a client-side message or packet comprising one or more of user's unique identifier and selected viewing identifier; processing, by the server-side computing device, records comprised in one or more of first data storage, second data storage, server-side data storage, and server-side memory, so as to create per-viewing allowance and per time-frame allowance of the media content; generating and transmitting, by the server-side computing device, to the client device, a server-side message or packet comprising one or more of user's unique identifier, selected viewing identifier, customization preferences of the user, media content unique identifier, media image URLs, media image URLs, per-viewing identifier, per-timeframe identifier, and sub-account preferences of the user; and processing, by the server-side computing device, records comprised in one or more of the first data storage, second data storage, server-side data storage, and server-side memory, so as to reduce the per-viewing allowance by a pre-determined amount of viewings.

According to other embodiments of the invention, a method for transacting per-viewing and per-timeframe purchase, license, rental, distribution and consumption of media content and product merchandise includes: obtaining and processing, by a client device under a user's control, a user's username and password by the user; generating and transmitting, by the client device, to a server-side computing device, a client-side message or packet comprising one or more of user's username and password; receiving and processing, by the client device, a server-side message or packet comprising one or more of user's unique identifier and an other unique identifier; obtaining and processing, by the client device, one or more of user's order and user's billing information by the user; generating and transmitting, by the client device, to the server-side computing device, a client-side message or packet comprising one or more of user's unique identifier, user's order, and user's billing information; receiving and processing, by the client device, a server-side message or packet comprising one or more order completion information and order completion notification; and creating and displaying, by the client device, one or more order completion confirmation and order completion notification.

According to further other embodiments of the invention, a method for transacting per-viewing and per-timeframe purchase, license, rental, distribution and consumption of media content and product merchandise includes: receiving and processing, by a server-side computing device, form a client device under a user's control, a client-side message or packet comprising one or more of user's username and password by the user; generating and transmitting, by the server-side computing device, to a client device, a server-side message or packet comprising one or more of user's unique identifier and an other unique identifier; receiving and processing, by the server-side computing device, a client-side message or packet comprising one or more of user's unique identifier, user's order, and user's billing information; transmitting, verifying and transacting, by the server-side computing device, the user's order and billing information with one or more of external server and internal server so as to receive payment transaction information and payment authorization information; creating, by the server-side computing device, segmented media content; creating, by the server-side computing device, one or more of a media content playlist and a unique playlist reference link; creating and uploading, a server-side message or packet comprising one or more of segmented media content, media content playlist, and unique playlist reference link to one or more of first data storage, second data storage, server-side data storage, and server-side memory; creating and uploading, a server-side message or packet comprising one or more records to one or more of first data storage, second data storage, server-side data storage, and server-side memory; and generating and transmitting, by the server-side computing device, to the client device, a server-side message or packet comprising one or more order completion information and order completion notification.

According to still other embodiments of the invention, a method for transacting a sub-account per-viewing and per-timeframe purchase, license, rental, distribution and consumption of media content and product merchandise includes: obtaining and processing, by a client device under a user's control, one or more of a sub-account and sub-account preferences by the user; receiving and processing, by a client device, from a server-side computing device, a server-side message or packet comprising one or more of user's unique identifier and an other identifier; obtaining and processing, by a client device, one or more of a sub-account order and user's billing information by the user; generating and transmitting, by the client device, to the server-side computing device, a client-side message or packet comprising one or more of user's unique identifier, sub-account order, and user's billing information; receiving and processing, by the client device, to the server-side computing device, a server-side message or packet comprising one or more order completion information and order completion notification; and creating and displaying, by the client device, one or more order completion confirmation and order completion notification.

According to yet other embodiments of the invention, a method for transacting a sub-account per-viewing and per-timeframe purchase, license, rental, distribution and consumption of media content and product merchandise includes: receiving and processing, by a server-side computing device, from a client device under a user's control, a client-side message or packet comprising one or more of sub-account and sub-account preferences; generating and transmitting, by the server-side computing device, to a client device, a server-side message or packet comprising one or more of user's unique identifier and an other unique identifier; receiving and processing, by the server-side computing device, from a client device, a client-side message or packet comprising one or more of user's unique identifier, sub-account order, and user's billing information; transmitting, verifying and transacting, by the server-side computing device, the sub-account order and user's billing information with one or more of external server and internal server so as to receive payment transaction information and payment authorization information; creating, by the server-side computing device, segmented media content; creating, by the server-side computing device, one or more of a media content playlist and a unique playlist reference link; creating and uploading, by the server-side computing device, a server-side message or packet comprising one or more of segmented media content, media content playlist, and unique playlist reference link to one or more of first data storage, second data storage, server-side data storage, and server-side memory; creating and uploading, by the server-side computing device, a server-side message or packet comprising one or more records to one or more of first data storage, second data storage, server-side data storage, and server-side memory; and generating and transmitting, by the server-side computing device, to the client device, a server-side message or packet comprising one or more order completion information and order completion notification.

According to further other embodiments of the invention, a method for uploading provider content for per-viewing and per-timeframe purchase, license, rental, distribution and consumption of media content and product merchandise includes: obtaining and processing, by a client device under a user's control, a media content provider's username and password by the user; generating and transmitting, by the client device, to a server-side computing device, a client-side message or packet comprising one or more of media content provider's username and password; obtaining and processing, by a client device, one or more of media content and media content database by the user; generating and transmitting, by the client device, to a server-side computing device, a client-side message or packet comprising one or more of media content, media content provider's unique identifier, and media content database; and receiving and processing, by a client device, from the server-side computing device, a server-side message or packet comprising one or more of upload completion confirmation and upload completion notification.

According to still other embodiments of the invention, a method for uploading provider content for per-viewing and per-timeframe purchase, license, rental, distribution and consumption of media content and product merchandise includes: receiving and processing, by a server-side computing device, from a client device under a user's control, a client-side message or packet comprising one or more of media content provider's username and password; generating and transmitting, by the server-side computing device, to a client device, a server-side message or packet comprising one or more of media content provider's unique identifier and an other unique identifier; receiving and processing, by the server-side computing device, from the client device, a client-side message or packet comprising one or more of media content, media content provider's unique identifier, and media content database; creating, by the server-side computing device, segmented media content; creating, by the server-side computing device, one or more of a media content playlist and a unique playlist reference link; creating and uploading, by the server-side computing device, a server-side message or packet comprising one or more of segmented media content, media content playlist, and unique playlist reference link to one or more of first data storage, second data storage, server-side data storage, and server-side memory; creating and uploading, by the server-side computing device, a server-side message or packet comprising one or more of media content database to one or more of first data storage, second data storage, server-side data storage, and server-side memory; and generating and transmitting, by the server-side computing device, to the client device, a server-side message or packet comprising one or more upload completion information and upload completion notification.

According to yet other embodiments of the invention, a method for authenticating per-viewing and per-timeframe purchase, license, rental, distribution and consumption of media content and product merchandise includes: obtaining and processing, by a client device under a user's control, a user's username and password by the user; creating and transmitting, by the client device, to the server-side computing device, a client-side message or packet comprising one or more of user's username and password to the server-side computing device; and receiving and processing, by the client device, from the server-side computing device, a server-side message or packet comprising one or more of user's unique identifier and an other unique identifier.

According to other embodiments of the invention, a method for authenticating per-viewing and per-timeframe purchase, license, rental, distribution and consumption of media content and product merchandise includes: receiving and processing, by a server-side computing device, from a client device under a user's control, a client-side message or packet comprising one or more of a user's username and password; and generating and transmitting, by the server-side computing device, to the client device, the server-side message or packet comprising one or more of user's unique identifier and an other unique identifier.

According to yet further embodiments of the invention, a server-side computing device for per-viewing and per-timeframe one or more purchase, license, rental, distribution and consumption of media content includes: a processor; data storage operably connected with the processor; memory operably connected with the processor, the memory comprising one or more of a server-side electronic commerce application, a server-side tracking application, a server-side data search application, a server-side transmission application, and a server-side streaming application; a server-side playback device operably connected with the processor; and a server-side local interface operably connected with the processor and configured to communicate over a network with a client device under a user's control; the server-side electronic commerce application configured to receive over the network from the client device a message or packet comprising per-viewing and per-timeframe media content and product merchandise, the server-side tracking application configured to query and process over the network particular search parameters in data storage and memory to verify the availability of per-viewing and per-timeframe media content selected by the user, the server-side data search application further configured to to query and process over the network one or more of records in data storage and memory to correspond with particular search parameters and initiate the access of per-viewing and per-timeframe media content selected by the user, the server-side transmission application configured to transmit over the network a message or packet to one or more of an external server and an internal server so as to one or more verify and transact the user's order and billing information, the server-side streaming application configured to segment media content for deployment via the network to the client device, the server-side local interface configured to transmit to the client device via the network server-side timing information and the per-viewing and per-timeframe media content so that the client device may substantially synchronize with its playback of the per-viewing and per-timeframe media content and product merchandise a playback by the server-side playback device.

### DESCRIPTION OF THE DRAWINGS

FIG. 1 is a schematic block diagram of a networked environment for per-viewing and per-timeframe purchase, license, rental, distribution and consumption of media content via one or more electronic devices.

FIG. 2 is a schematic block diagram of a server-side computing device in an alternative configuration of a networked environment for per-viewing and per-timeframe purchase, license, rental, distribution and consumption of media content via one or more of electronic devices.

FIG. 3 is a flowchart of a method for per-viewing and per-timeframe purchase, license, rental, distribution and consumption of media content and product merchandise. FIG. 3 applies to the method viewed from the client side.

FIG. 4 is a flowchart of a method for per-viewing and per-timeframe purchase, license, rental, distribution and consumption of media content and product merchandise. FIG. 4 applies to the method viewed from the server side.

FIG. 5 is a flowchart of a method for viewing per-viewing and per-timeframe purchase, license, rental, distribution and consumption of media content and product merchandise. FIG. 5 applies to the method viewed from the client side.

FIG. 6 is a flowchart of a method for viewing per-viewing and per-timeframe purchase, license, rental, distribution and consumption of media content and product merchandise. FIG. 6 applies to the method viewed from the server side.

FIG. 7 is a flowchart of a method for transacting per-viewing and per-timeframe purchase, license, rental, distribution and consumption of media content and product merchandise. FIG. 7 applies to the method viewed from the client side.

FIG. 8 is a flowchart of a method for transacting per-viewing and per-timeframe purchase, license, rental, distribution and consumption of media content and product merchandise. FIG. 8 applies to the method viewed from the server side.

FIG. 9 is a flowchart of a method for transacting a sub-account per-viewing and per-timeframe purchase, license, rental, distribution and consumption of media content and product merchandise. FIG. 9 applies to the method viewed from the client side.

FIG. 10 is a flowchart of a method for transacting a sub-account per-viewing and per-timeframe purchase, license, rental, distribution and consumption of media content and product merchandise. FIG. 10 applies to the method viewed from the server side.

FIG. 11 is a flowchart of a method for uploading provider content for per-viewing and per-timeframe purchase, license, rental, distribution and consumption of media content and product merchandise. FIG. 11 applies to the method from the client side.

FIG. 12 is a flowchart of a method for uploading provider content for per-viewing and per-timeframe purchase, license, rental, distribution and consumption of media content and product merchandise. FIG. 12 applies to the method from the server side.

FIG. 13 is a flowchart of a method for authenticating per-viewing and per-timeframe purchase, license, rental, distribution and consumption of media content and product merchandise. FIG. 13 applies to the method from the client side.

FIG. 14 is a flowchart of a method for authenticating per-viewing and per-timeframe purchase, license, rental, distribution and consumption of one or more of media content and product merchandise. FIG. 14 applies to the method from the server side.

FIG. 15 is an exemplary screenshot of a graphical user interface (GUI) of a client device in a networked environment showing a screen initially displayed to a user prior to viewing per-viewing and per-timeframe purchase, license, rental, distribution and consumption of one or more of media content and product merchandise.

FIG. 16 is an exemplary screenshot of a GUI of a client device in a networked environment that displays the viewings available to a user prior to selecting a first viewing of per-viewing and per-timeframe purchase, license, rental, distribution and consumption of one or more of media content and product merchandise.

FIG. 17 is an exemplary screenshot of a GUI of a client device in a networked environment that displays a selection confirmation prompt to a user prior to consuming a viewing of per-viewing and per-timeframe purchase, license, rental, distribution and consumption of one or more of media content and product merchandise.

FIG. 18 is an exemplary screenshot of a GUI of a client device in a networked environment that displays an example of a player screen.

FIG. 19 is an exemplary screenshot of a GUI of a client device in a networked environment that displays the viewings available to a user after consuming a first viewing and prior to selecting a second viewing of per-viewing and per-timeframe purchase, license, rental, distribution and consumption of media content.

FIG. 20 is an exemplary screenshot of a GUI of a client device in a networked environment that displays an item purchase screen seen by a user purchasing additional viewings of per-viewing and per-timeframe purchase, license, rental, distribution and consumption of media content previously purchased by the user.

FIG. 21 is an exemplary screenshot of a GUI of a client device in a networked environment that displays a screen initially displayed to a user after purchasing additional viewings of per-view and per-timeframe purchase, license, rental, distribution and consumption media content previously purchased by the user.

FIG. 22 is an exemplary screenshot of a GUI of a client device in a networked environment that displays an example of how the GUI receives a selection of customization preferences of the user for per-viewing and per-timeframe purchase, license, rental, distribution and consumption of one or more of media content and product merchandise.

### DETAILED DESCRIPTION

While the present invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the following description and in the several figures of the drawings, like reference numerals are used to describe the same, similar or corresponding parts in the several views of the drawings.

The system for the per-viewing and per-timeframe purchase, license, rental, distribution and consumption of one or more of media content and product merchandise via one or more electronic devices includes a plurality of components such as one or more of electronic components, hardware components, and computer software components. A number of such components can be combined or divided in the system. An example component of the system includes a set and/or series of computer instructions written in or implemented with any of a number of programming languages, as will be appreciated by those skilled in the art.

The system in one example employs one or more computer-readable signal-bearing media. The computer-readable signal bearing media store software, firmware and/or assembly language for performing one or more portions of one or more implementations of the invention. The computer-readable signal-bearing medium for the system in one example comprises one or more of a magnetic, electrical, optical, biological, and atomic data storage medium. For example, the computer-readable signal-bearing medium comprises floppy disks, magnetic tapes, CD-ROMs, DVD-ROMs, hard disk drives, downloadable files, files executable “in the cloud,” and electronic memory.

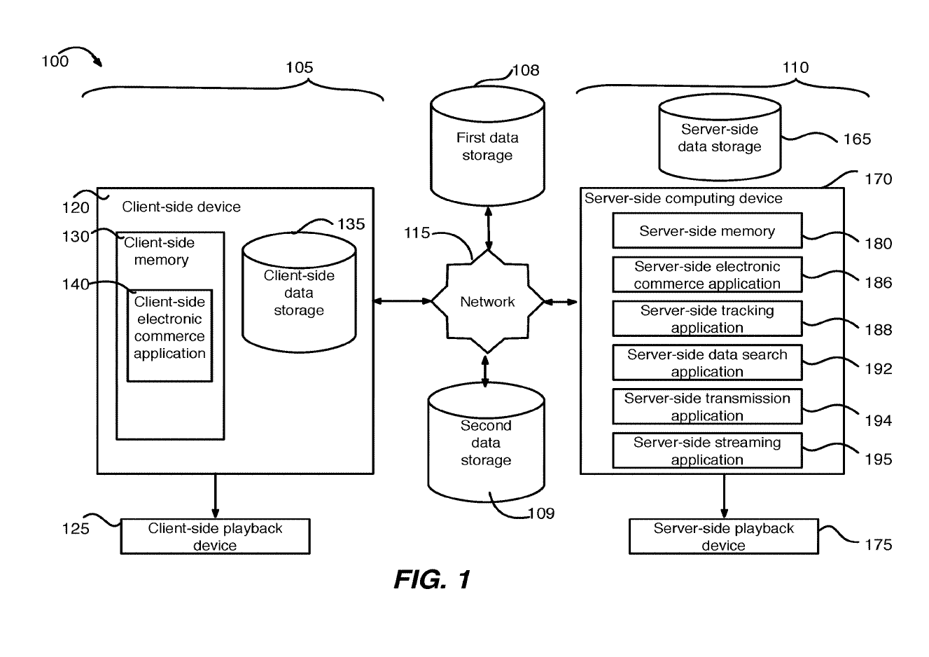

FIG. 1 is a schematic block diagram of a networked environment 100 for pre-viewing and per-timeframe purchase, license, rental, distribution and consumption of media content via one or more of electronic devices that comprises a client-side networked environment 105, a server-side networked environment 110, and a network 115. The network 115 comprises one or more of first data storage 108, second data storage 109, the Internet, a private virtual network, an extranet, a fiber optic network, a wide area network (WAN), a local area network (LAN), a wired network, a wireless network, and another type of network.

The client-side networked environment 105 comprises a client device 120, a client-side playback device 125 that is operably connected with the client device 120, and client-side data storage 135. The client device 120 comprises, for example, one or more of a tablet, a phone, a smart device, a virtual reality headset, a computer program, a computer browser, a media player, a game console, a virtual device, and another computing device.

The client device 120 processes a user's selection to purchase, license, rent, distribute, and consume of one or more of media content and product merchandise. For example, the client device 120 processes the user's selection of media content to match media content stored in one or more of first store 108, second data store 109, and client-side data storage 135. Alternatively, or additionally, the client device 120 may create new media content. The media content may be one or more of encrypted, non-encrypted, compressed, and non-compressed. For example, the client device 120 processes the user's selection of product merchandise to match product merchandise stored in the client-side data storage 135. Alternatively, or additionally, the client device 120 may create new product merchandise. The product merchandise may be one or more of encrypted, non-encrypted, compressed, and non-compressed.

For example, the client device 120 may create a new video media content. The client device 120 may create the new video media content by one or more of executing a text-to-audio algorithm, executing a speech recognition algorithm, executing animation effects, executing audio effects, executing visual effects, executing an algorithm based on trends, making a random selection of the new video media content, making a selection of the new video media content, and by another method for making new video media content. The client device 120 may create the new video media content based on one or more of a media selected by the user, a media selected by a sub-account of the user, a media selected by another user, the user's historical purchases, the sub-account's historical purchases, the user's consumption history, the sub-account's consumption history, the user's recommended items, the sub-account's recommended items, items recommended by the system to users, items recommended by the system to sub-accounts, and another video criterion.

The client device 120 runs one or more applications. The client device 120 deploys over the network 115.

The client-side playback device 125 is configured to play media content. For example, the client-side playback device 125 plays media content received from the client device 120. Alternatively, or additionally, the client-side playback device 125 plays media content received directly over the network 115. For example, the client-side playback device 125 comprises one or more of a headphone, a pair of earphones, a pair of earbuds, earworn wearables, a screen, a television, a monitor, an in-venue projector, a home theater, a television, a monitor, a three-dimensional digital projector, and another client-side playback device. For example, the client-side playback device 125 comprises one or more of an open headphone 125, a semi-open headphone 125, a closed headphone 125, and another type of headphone 125. For example, the client-side playback device 125 operates in one or more of a single-channel environment and a multi-channel speaker environment. For example, the client-side playback device 125 operates in a Dolby Atmos environment.

The client device 120 comprises one or more of client-side memory 130 and a client-side data storage 135.

The client-side memory 130 is defined herein as including both volatile and nonvolatile memory and data storage components. For example, the client-side memory 130 comprises one or more client-side buffers. Volatile components are those that do not retain data values upon loss of power. Nonvolatile components are those that retain data upon loss of power. For example, the client-side memory 130 may comprise one or more of random access memory (RAM), read-only memory (ROM), hard disk drive, solid-state drive, USB flash drive, memory card, floppy disk, optical disc such as compact disc (CD) or digital versatile disc (DVD), magnetic tape, and other memory components. For example, the RAM may comprise one or more of static random access memory (SRAM), dynamic random access memory (DRAM), magnetic random access memory (MRAM), and other forms of RAM. For example, the ROM may comprise one or more of programmable read-only memory (PROM), erasable programmable read-only memory (EPROM), electrically erasable programmable read-only memory (EEPROM), and other forms of ROM.

The client-side memory 130 comprises a client-side electronic commerce application 140.

The client-side memory 130 further comprises a client device unique identifier. The client device unique identifier is a number unique to this particular device. In other words, each device in the world will have its own number that no other such device will have. A copy of the client device unique identifier, known as a client-side unique identifier, will be transmitted by the client in a message or packet to the server. Then a copy of the client-side transmitted unique identifier, known as a server-side unique identifier, will be transmitted back from the server to the client. The server-side unique identifier received by the client will then be compared with the client device unique identifier to help determine the integrity of the messages and as a security check.

Optionally, the client-side memory 130 further comprises an other client-side application (not pictured). The other client-side application comprises one or more of an additional client-side application, an additional client-side service, an additional client-side process, and an additional client-side functionality.

For example, the other client-side application runs background services. For example, the other client-side application runs boot processes. For example, the other client-side application runs other client-side applications.

First data storage 108, second data storage 109, and client-side data storage 135 comprise one or more of a single database, a multiple database, a cloud application platform, a relational database, a no-sequel database, flash memory, solid state memory, and another client-side data storage device. First data storage 108, second data storage 109, and client-side data storage 135 may be located in a single installation that may be local to the server-side computing device 110. Alternatively, first data storage 108, second data storage 109, and client-side data storage 135 may be located in a single installation that may be local to the client device 120. Alternatively, first data storage 108, second data storage 109, and client-side data storage 135 may be distributed in a plurality of locations. First data storage 108, second data storage 109, and client-side data storage 135 may be distributed in a plurality of geographical locations. First data storage 108, second data storage 109, and client-side data storage 135 may be distributed in a plurality of geographical locations located in the same time zone. First data storage 108, second data storage 109, and client-side data storage 135 may be distributed in a plurality of geographical locations, wherein not all the geographical locations are located in the same time zone.

First data storage 108, second data storage 109, and client-side data storage 135 comprises one or more of item prices, order information, media content, and other information. The media content comprises one or more of media data, media content files, and other media content. For example, the media content files comprises one or more of an audio track, a video track, an other media track, a motion picture, a commercial, a motion picture trailer, a demonstration (“demo”), a commentary, extra content, and another form of additional content. The motion picture comprises one or more of a feature-length theatrical production, short-film production, an animated production, a broadcast television production, a pay television production, a documentary, a commercial, a trailer, and another motion picture. For example, the audio track comprises one or more of an English language audio track, an audio track in a language other than English, and a customized audio track. For example, the commentary comprises one or more of a commentary by one or more directors of a motion picture, a commentary by one or more actors in a motion picture, a commentary by contributors to a motion picture other than the directors and actors, and a commentary by persons other than contributors to a motion picture.

The client-side electronic commerce application 140 is configured to perform one or more of receiving user orders, fulfilling user orders and delivering ordered products to an ordering user. The client-side electronic commerce application 140 is configured to execute online purchases placed by the user of one or more of physical goods, services, and media content. The client-side electronic commerce application 140 is further configured to optionally customize the one or more of physical goods, services, and media content. For example, an additional charge may apply to a user wishing to have customized the one or more of physical goods, services, and media content. For example, the one or more of physical goods, services, and media content may be customized by adding one or more of a user-specified name, a user-specified message, a user-specified likeness, and another form of customization specified by the user.

For example, the user-specified name may comprise a name of a character comprised in the digital media content. For example, the digital media content comprises a motion picture. For example, if a motion picture is titled, “Joe's and Sport's Exciting Trip” and describes a road trip by a man Joe and his dog Sport, the user-specified name may be “Joe.” For example, the user may insert the user's own name as the name of one of the characters in the digital media content. For example, a user named Hamilton may insert “Hamilton” as the name of the character known in the motion picture as Joe. For example, the user may insert the name of his or her pet as the name of one of the animals in the digital media content. For example, if Hamilton has a dog named Champ, Hamilton may insert “Champ” as the name of the dog known in the motion picture as Sport.

For example, the user-specified likeness may comprise a hair color of a character comprised in the physical goods. For example, the user may insert the user's own hair color in one of the characters in the physical goods. For example, the user may insert a color of red hair when the color of the hair of the character known as Joe is brown.

The server-side networked environment 110 comprises server-side data storage 165, server-side computing device 170 that is operably connected with the server-side data storage 165, and server-side playback device 175 that is operably connected with server-side data storage 165. Server-side data storage 165 is a second location where, as mentioned above in relation to first data storage 108, second data storage 109, and client-side data storage 135, playable media content may store.

The server-side data storage 165 comprises one or more of a single database, a multiple database, a cloud application platform, a relational database, a no-sequel database, flash memory, solid state memory, and another server-side data storage device. The server-side data storage 165 may be located in a single installation that may be local to the client device 120. Alternatively, the server-side data storage 165 may be located in a single installation that may be local to the server-side computing device 170. Alternatively, the server-side data storage 165 may be distributed in a plurality of locations. The server-side data storage 165 may be distributed in a plurality of geographical locations. The server-side data storage 165 may be distributed in a plurality of geographical locations located in the same time zone. The server-side data storage 165 may be distributed in a plurality of geographical locations, wherein not all the geographical locations are located in the same time zone.

The server-side data storage 165 comprises one or more of item prices, order information, media content, and other information. The media content comprises one or more of media data, media content files, and other media content. For example, the media content files comprises one or more of an audio track, a video track, an other media track, a motion picture, a commercial, a motion picture trailer, a demonstration (“demo”), a commentary, extra content, and another form of additional content. The motion picture comprises one or more of a feature-length theatrical production, short-film production, an animated production, a broadcast television production, a pay television production, a documentary, a commercial, a trailer, and another motion picture. For example, the audio track comprises one or more of an English language audio track, an audio track in a language other than English, and a customized audio track. For example, the commentary comprises one or more of a commentary by one or more directors of a motion picture, a commentary by one or more actors in a motion picture, a commentary by contributors to a motion picture other than the directors and actors, and a commentary by persons other than contributors to a motion picture.

The server-side computing device 170 comprises one or more of a server, a computer, a cloud-computing device, and a distributed computing system.

Optionally, the server-side computing device 170 further comprises an other server-side application (not pictured). The other server-side application comprises one or more of an additional server-side application, an additional server-side service, an additional server-side process, and an additional server-side functionality.

For example, the other server-side application runs background services. For example, the other server-side application runs boot processes. For example, the other server-side application runs other server-side applications.

The server-side computing device 170 may be located in a single installation. Alternatively, the server-side computing device 170 may be distributed in a plurality of geographical locations. For example, the server-side computing device 170 may be distributed in a plurality of geographical locations located in the same time zone. For example, the server-side computing device 170 may be distributed in a plurality of geographical locations wherein not all the geographical locations are located in the same time zone.

The server-side playback device 175 is configured to play media content. For example, the server-side playback device 175 plays media content received from the server-side computing device 170. Alternatively, or additionally, the server-side playback device 175 plays media content received directly over the network 115. For example, the server-side playback device 175 comprises one or more of a headphone, a pair of earphones, a pair of earbuds, earworn wearables, a screen, a television, a monitor, an in-venue projector, a home theater, a television, a monitor, a three-dimensional digital projector, and another device. For example, the client-side playback device 175 comprises one or more of an open headphone 175, a semi-open headphone 175, a closed headphone 175, and another type of headphone 175. The server-side playback device 175 is configured to communicate with the server-side computing device 170. For example, the server-side playback device 175 communicates with the server-side computing device 170 using one or more of a satellite, an antenna, a cable, the network 115, and another communication method.

The server-side computing device comprises a server-side memory 180. The server-side memory 180 is defined herein as including both volatile and nonvolatile memory and data storage components. For example, the server-side memory 180 comprises one or more server-side buffers. Volatile components are those that do not retain data values upon loss of power. Nonvolatile components are those that retain data upon loss of power. For example, the server-side memory 180 may comprise one or more of random access memory (RAM), read-only memory (ROM), hard disk drive, solid-state drive, USB flash drive, memory card, floppy disk, optical disc such as compact disc (CD) or digital versatile disc (DVD), magnetic tape, and other memory components. For example, the RAM may comprise one or more of static random access memory (SRAM), dynamic random access memory (DRAM), magnetic random access memory (MRAM), and other forms of RAM. For example, the ROM may comprise one or more of programmable read-only memory (PROM), erasable programmable read-only memory (EPROM), electrically erasable programmable read-only memory (EEPROM), and other forms of ROM. For example, the RAM may comprise one or more of static random access memory (SRAM), dynamic random access memory (DRAM), magnetic random access memory (MRAM), and other forms of RAM. For example, the ROM may comprise one or more of programmable read-only memory (PROM), erasable programmable read-only memory (EPROM), electrically erasable programmable read-only memory (EEPROM), and other forms of ROM.

The server-side memory 180 comprises one or more of a server-side electronic commerce application 186, a server-side tracking application 188, a server-side data search application 192, a server-side transmission application 194, and a server-side streaming application 195. The server-side electronic commerce application 186 is configured to provide per-viewing and per-timeframe media content and product merchandise information to one or more of the client-side electronic commerce application 140 and the server-side streaming application 195.

The server-side tracking application 188 queries and processes particular search parameters to verify the availability of per-viewing and per-timeframe media content and product merchandise selected by the user to one or more of the client-side electronic application 140 and the server-side streaming application 195. Further, the server-side tracking application 188 is configured to perform calculations between one or more values. For example, the server-side tracking application keeps track of daylight saving time differences, time zone differences, seasonal differences, date differences, time offsets, and the like. For example, the server-side tracking application may compute time as seconds relative to an absolute reference of time, such as, for example, the first instant of Jan. 1, 2016, Greenwich Mean Time (GMT.)

The server-side data search application 192 queries and processes one or more records of first data store 108, second data store 109, server-side data store 165, and server-side memory 180. Alternative or additionally, the server-side data search application 192 may receive one or more query parameters from one or more of the server-side electronic commerce application 186 and the server-side tracking application 188. The server-side data search application 192 may determine one or more matches in the first data store 108, second data store 109, server-side data store 165, and server-side memory 180.

For example, a match may be performed by corresponding particular search parameters with at least one field of one or more records stored in one or more of server-side data store and server-side memory. Alternatively, or additionally, a match may be performed by corresponding particular search parameters with at least one field of one or more records as the store is being processed. A match may be further performed by determining which records comprise information that most closely resembles the particular search parameters. A match may further be performed by determining which records comprise information that does not closely resemble the particular search parameters. Alternatively, or additionally, the match may be performed by comparing one or more simple key and complex key to another.

The server-side transmission application 194 transmits over the network 115 a message or packet to one or more of an external server and an internal server so as to one or more verify and transact the user's order and billing information. For example, the server-side transmission application 194 facilitates the utilization of the server-side data search application 192 with one or more of software development kits (“SDK”) and application-programming interfaces (“API”) provided to a third-party service provider.

The server-side streaming application 195 segments media content for deployment via the network 115 to the client device 120. The server-side streaming application 195 supports multiple alternate data streams, two or more of which can have different bit rates from each other. The server-side streaming application 195 also allows for the client device 120 to switch streams intelligently as network bandwidth changes. The server-side streaming application 195 also provides for media encryption and user authentication over encrypted connections.

Optionally, one or more client-side messages or packets may be encrypted. Optionally, one or more server-side messages or packets may be encrypted.

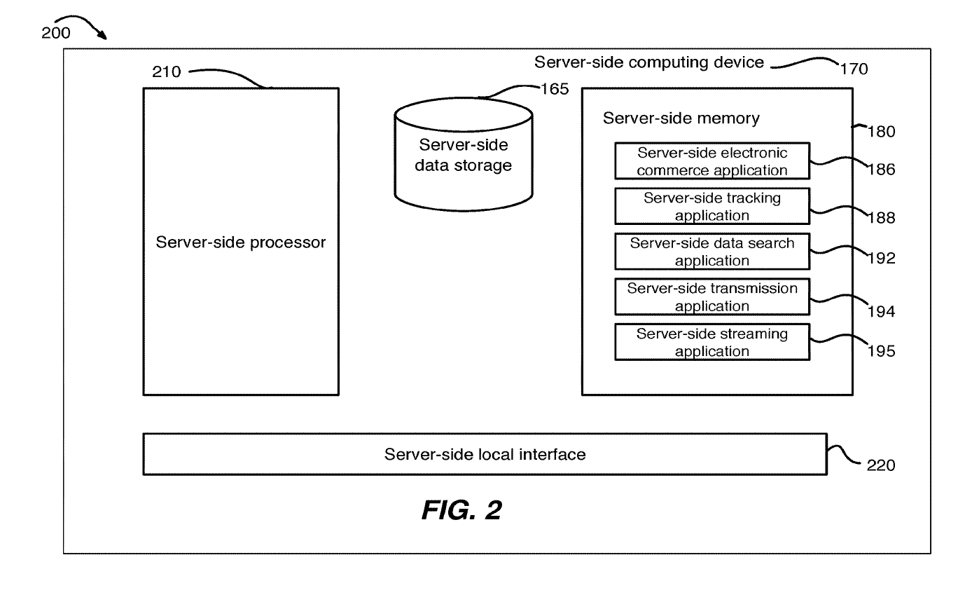

FIG. 2 is a schematic block diagram of the server-side computing device 170 in an alternative configuration of a networked environment for per-viewing and per-timeframe purchase, license, rental, distribution and consumption of media content via one or more of electronic devices.

The server-side computing device 170 comprises one or more of the server-side data storage 165, the server-side playback device 175 (not pictured), the server-side memory 180, a server-side processor 210, and a server-side local interface 220. The server-side local interface 220 is operationally connected with one or more of the server-side data storage 165, the server-side playback device 175, the server-side memory 180, and the server-side processor 210. The server-side memory comprises one or more of the server-side electronic commerce application 186, the server-side tracking application 188, the server-side data search application 192, the server-side transmission application 194, and the server-side streaming application 195. For example, the server-side processor 210 comprises a server-side computer. For example, the server-side local interface 220 comprises a bus. For example, the server-side local interface 220 comprises a bus and further comprises one or more of an accompanying address/control bus or other bus structure.

Software components stored in one or more of the server-side memory 180 and the server-side data storage 165 are executable by the server-side processor 210. In this respect, the term executable means a program file that is in a form that can ultimately be run by the server-side processor 210. For example, a compiled program is executable if it may be translated into machine code in a format that can be loaded into a random access portion of the server-side memory 180 and run by the server-side processor 210. For example, source code is executable if it may be expressed in a proper format, such as object code, that may be loaded into a random access portion of the server-side memory 180 and run by the server-side processor 210. For example, source code is executable if it may be interpreted by another executable program to generate instructions in a random access portion of the server-side memory 180 and run by the server-side processor 210. An executable program may be stored in one or more portions or components of the server-side memory 180. For example, the server-side memory 180 comprises one or more of random access memory (RAM), read-only memory (ROM), hard disk drive, solid-state drive, USB flash drive, memory card, floppy disk, optical disc such as compact disc (CD) or digital versatile disc (DVD), magnetic tape, and other memory components. For example, the RAM may comprise one or more of static random access memory (SRAM), dynamic random access memory (DRAM), magnetic random access memory (MRAM), and other forms of RAM. For example, the ROM may comprise one or more of programmable read-only memory (PROM), erasable programmable read-only memory (EPROM), electrically erasable programmable read-only memory (EEPROM), and other forms of ROM. For example, the RAM may comprise one or more of static random access memory (SRAM), dynamic random access memory (DRAM), magnetic random access memory (MRAM), and other forms of RAM. For example, the ROM may comprise one or more of programmable read-only memory (PROM), erasable programmable read-only memory (EPROM), electrically erasable programmable read-only memory (EEPROM), and other forms of ROM.

One or more of data and components stored in one or more of the server-side memory 180 and the server-side data storage 165 are executable by the server-side processor 210. For example, the server-side processor 210 can execute one or more of the server-side electronic commerce application 186, the server-side tracking application 188, the server-side data search application 192, the server-side transmission application 194, and the server-side streaming application 195.

For example, as an alternative to the setup in FIG. 1 with the server-side data storage 165 separate from the server-side computing device 170, the server-side data storage 165 may be located in the server-side computing device 170. For example, the server-side data storage 165 may be located in the server-side memory 180.

The server-side processor 210 comprises one or more processors. The server-side memory 180 comprises one or more memories. For example, the server-side memory 180 comprises at least one memory configured to operate in a parallel processing circuit. In such a case, the server-side local interface 220 may serve as the network 115. For example, the server-side local interface 220 may facilitate communication between two processors. For example, the server-side local interface 220 may facilitate communication between a processor and a memory. For example, the server-side local interface 220 may facilitate communication between two memories. The server-side local interface 220 may comprise additional systems designed to coordinate this communication. For example, the server-side local interface 220 may comprise a system to perform load balancing. The server-side processor 210 may comprise an electrical processor. Alternatively, or additionally the server-side processor 210 may comprise a non-electrical processor.

Any logic or application described herein, including but not limited to the server-side electronic commerce application 186, the server-side tracking application 188, the server-side data search application 192, the server-side transmission application 194, and the server-side streaming application 195 that comprises software or code can be embodied in any non-transitory computer-readable medium for use by or in connection with an instruction execution system such as, for example, a server-side processor 210 in a computer system or other system. In this sense, the logic may comprise, for example, statements including instructions and declarations that can be fetched from the computer-readable medium and can be executed by the instruction execution system. In the context of the present disclosure, a computer-readable medium can be any medium that can contain, store, or maintain the logic or application described herein for use by or in connection with the instruction execution system. For example, the computer-readable medium may comprise one or more of RAM, ROM, hard disk drive, solid-state drive, USB flash drive, memory card, floppy disk, optical disc such as a CD or a DVD, magnetic tape, and other memory components. For example, the RAM may comprise one or more of SRAM, DRAM, MRAM, and other forms of RAM. For example, the ROM may comprise one or more of PROM, EPROM, EEPROM, and other forms of ROM.

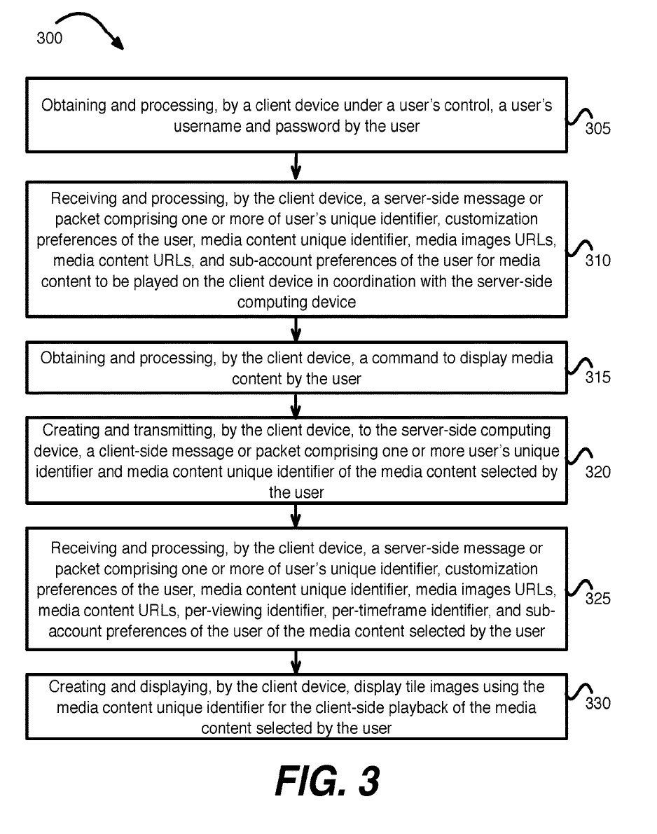

FIG. 3 is a flowchart of a method for per-viewing and per-timeframe purchase, license, rental, distribution and consumption of media content and product merchandise. FIG. 3 applies to the method viewed from the client side.

The order of the steps in the method 300 is not constrained to that shown in FIG. 3 or described in the following discussion. Several of the steps could occur in a different order without affecting the final result.

According to this method, the client-side electronic commerce application in the client device initiates access of media content with the server-side electronic commerce application in the server computing device.

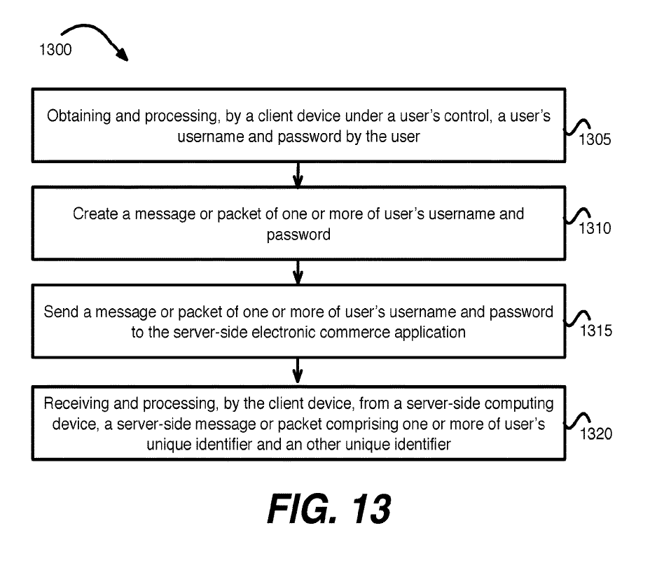

In block 305, a client-side electronic commerce application receives from a client device under a user's control and processes one or more user's username and password, then sends one or more user's username and password to the server-side electronic commerce application. FIG. 13 provides more detail regarding sub-steps of step 305 in FIG. 3. Block 305 then transfers control to block 310.

Next, in block 310, the client-side commerce application receives from the server-side electronic commerce application and processes a message or packet comprising one or more user's unique identifier, customization preferences of the user, media content unique identifier, media image URLs, media content URLs, sub-account preferences of the user, and an other media content view information. For example, media content unique identifier comprises one or more of unique identifier used to query the first data storage, second data storage, server-side data storage and server-side memory for one or more of media content, product merchandise, and an other view information.

For example, media image URLs comprise one or more of links to images located on the first data storage, second data storage, server-side data storage, and server-side memory. For example, the images display to the user may comprise one or more of customized images and random images that link to media content unique identifier. Alternatively, or additionally, the images may be generated based on a user's search history, rating of media content, customization preferences of the user, user's account information, time zone, regional language usage, and an other basis for image display generation. For example, a rating of the media content comprises one or more of rating by the Motion Picture Association of America, a violence content advisory level, a TV Parental Guideline, a sexual content advisory, and an other rating of the media content.

For example, media content URLs comprise one or more of links to media content located on the first data storage, second data storage, server-side data storage and server-side memory. For example, the media content URLs may be one or more of a playlist that supports multiple alternate data streams, two or more of which can have different bit rates from each other. Block 310 then transfer control to block 315.

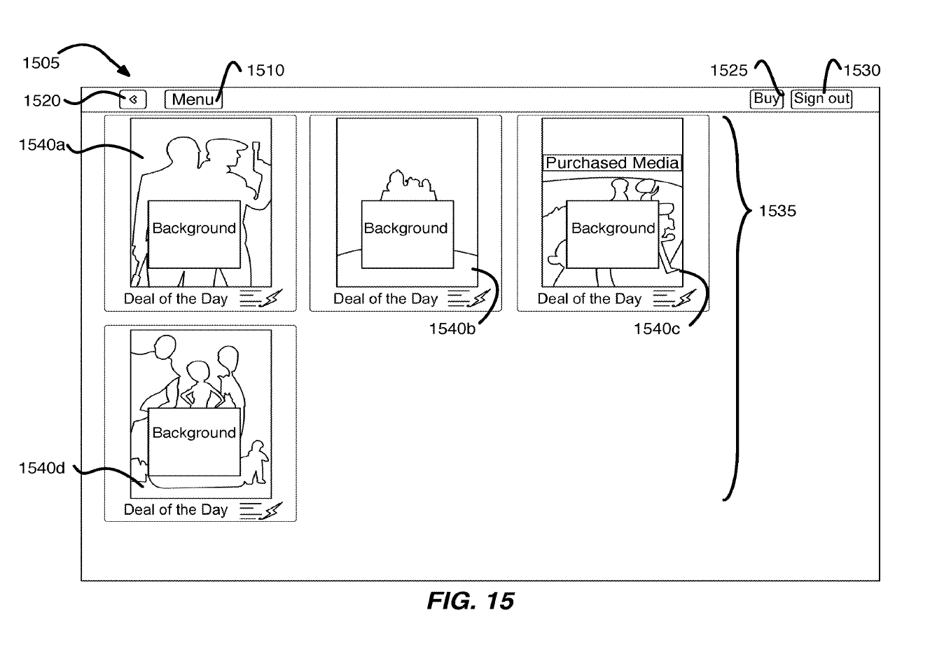

Next, in block 315, the client-side electronic commerce application receives a command. For example, the command comprises one or more of media content unique identifier and an other identifier. For example, the command may be performed by pressing one or more of the images displayed, a media image URL, a hyperlink, a button and a tab by the user as such may be given in FIG. 15. Block 315 then transfers control to block 320.

Next, in block 320, the client-side electronic commerce application sends to the server-side electronic commerce application a message or packet comprising one or more user's unique identifier and media content unique identifier, Block 320 then transfers control to block 325.

Next, in block 325, the client-side electronic commerce application receives from the server-side electronic application a message or packet comprising one or more user's unique identifier, customization preferences of the user, media content unique identifier, media image URLs, media content URLs, per-viewing identifier, per-timeframe identifier, sub-account preferences of the user, and an other media content view information.

For example, a per-viewing identifier comprises one or more of unique identifier used to query the first data storage, second data storage, server-side data storage and server-side memory for one or more of media content and per-viewing information.

For example, a per-timeframe identifier comprises one or more of unique identifier used to query the first data storage, second data storage, server-side data storage and server-side memory for one or more of media content and per-timeframe information. Block 325 then transfers control to block 330.

Next, in block 330, the client-side electronic application processes one or more of user's unique identifier, customization preferences of the user, media content unique identifier, media image URLs, media content URLs, per-viewing identifier, per-timeframe identifier, sub-account preferences of the user, and an other media content view information. For example, the processing may comprise the generation of display tile images of the media content unique identifier selected by the user. For example, the tile images display the number of viewings of the media content transacted by the user and made available to the user for consumption. Block 330 then terminates the process.

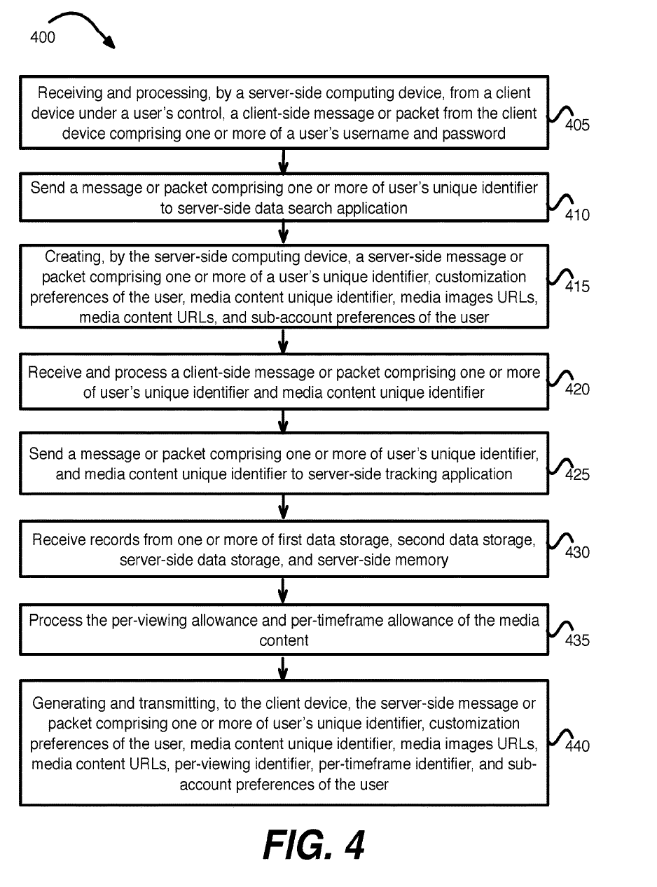

FIG. 4 is a flowchart of a method for creating per-viewing and per-timeframe purchase, license, rental, distribution and consumption of media content and product merchandise. FIG. 4 applies to the method viewed from the server side.

The order of the steps in the method 400 is not constrained to that shown in FIG. 4 or described in the following discussion. Several of the steps could occur in a different order without affecting the final result.

According to this method, the client-side electronic commerce application in the client device initiates access of media content with the server-side electronic commerce application in the server computing device.

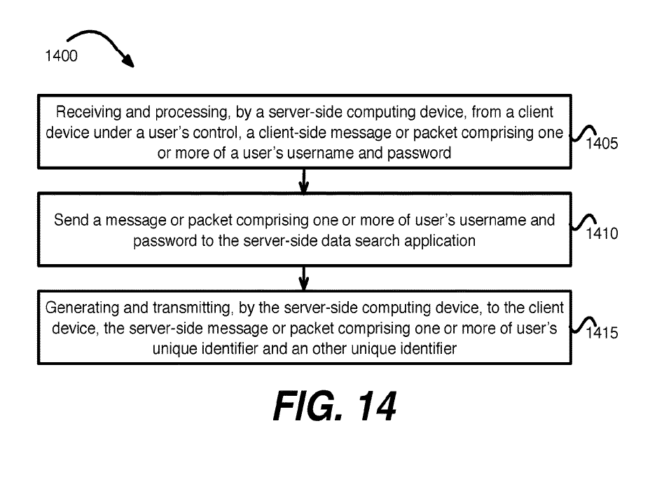

In block 405, the server-side electronic commerce application receives and processes a message or packet comprising one or more of user's username and password from the client-side electronic commerce application. FIG. 14 provides more detail regarding the sub-steps of step 405 in FIG. 4. Block 405 then transfers control to block 410.

Next, in block 410, the server-side electronic commerce application sends a message or packet comprising one or more of user's unique identifier to the server-side data search application. Block 410 then transfers control to block 415.

Next, in block 415, the server-side electronic commerce application, using the server-side data search application, queries one or more of first data storage, second data storage, server-side data storage and server-side memory to correspond particular search parameters using the user's unique identifier. If the query results do not correspond within the particular search parameters, the server-side electronic commerce application sends an error code to the client-side electronic commerce application, then the process loops back to step 405.

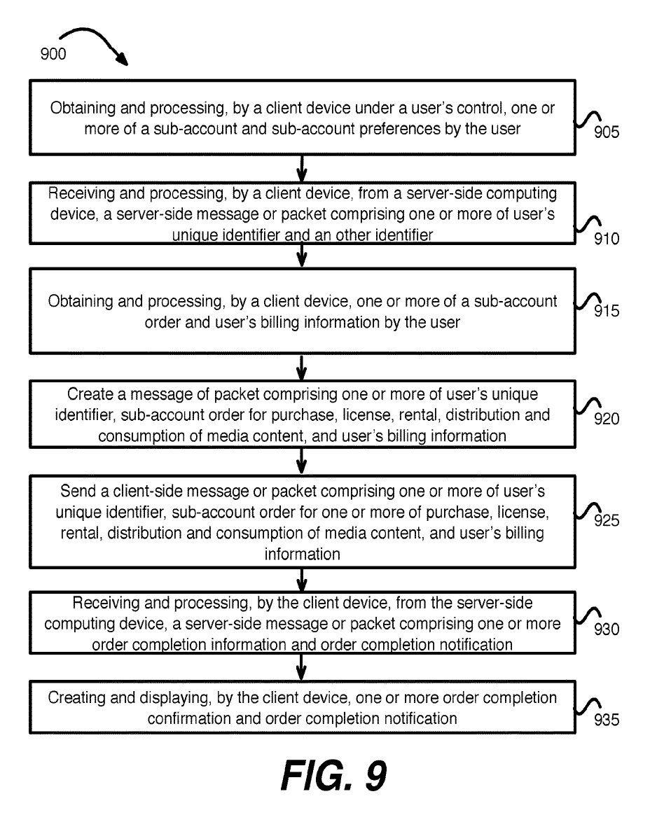

If the query results do correspond within the particular search parameters, the server-side electronic commerce application then sends a message or packet comprising one or more user's unique identifier, customization preferences of the user, media content unique identifier, media image URLs, media content URLs, sub-account preferences of the user, and an other media content view information to the client-side electronic commerce application. FIG. 9 provides more detail regarding sub-steps of step 415. Block 415 then transfers control to block 420.

Next, in block 420, the server-side electronic commerce application receives from the client-side electronic commerce application and processes a message or packet comprising one or more of user's unique identifier and media content unique identifier. Block 420 then transfers control to block 425.

Next, in block 425, the server-side electronic commerce application sends to the server-side tracking application a message or packet comprising one or more of user's unique identifier and media content unique identifier. Block 425 then transfers control to block 430.

Next, in block 430, the server-side electronic commerce application, using the server-side tracking application, queries one or more of first data storage, second data storage, server-side data storage and server-side memory to correspond particular search parameters using user's unique identifier and media content unique identifier. If the query results do not correspond within the particular search parameters, the server-side electronic commerce application sends an error code to the client-side electronic commerce application, then the process loops back to step 410.

If the query results do correspond within the particular search parameters, the server-side tracking application receives from one or more of first data storage, second data storage, server-side data storage and server-side memory one or more results of the query. For example, the server-side tracking application may receive one or more records of one or more fields of user's unique identifier, customization preferences of the user, media content unique identifier, media image URLs, media content URLs, per-viewing identifier, per-timeframe identifier, sub-account preferences of the user, and an other media content view information. Block 430 then transfers control to block 435.

Next, in block 435, the server-side tracking application processes the results of the query. For example, the processing of the query comprises the verification that the per-timeframe identifier value is greater than zero, and subsequently that the per-viewing identifier value is greater than zero. For example, one or more of per-viewing allowance and per-timeframe allowance for a media content to be consumed may be for a pre-determined amount of viewings within a pre-determined time span. For example, the media content to be consumed may be restricted by an other criteria than for one or more of per-viewing allowance and per-timeframe allowance.

If the processing of the query does not verify that per-timeframe identifier value is greater than zero, and subsequently that per-viewing identifier value is greater than zero, then the server-side tracking application sends to the client-side electronic commerce application a notification that the verification has been declined, then the process loops back to step 405.

If the processing of the query verifies that per-timeframe identifier value is greater than zero, and subsequently that per-viewing identifier value is greater than zero, then block 435 transfers control to block 440.

Next, in block 440, the server-side tracking application sends to the client-side electronic commerce application a message or packet comprising one or more of user's unique identifier, customization preferences of the user, media content unique identifier, media images URLs, media content URLs, per-viewing identifier, per-timeframe identifier, sub-account preferences of the user, and an other media content view information. Block 440 then terminates the process.

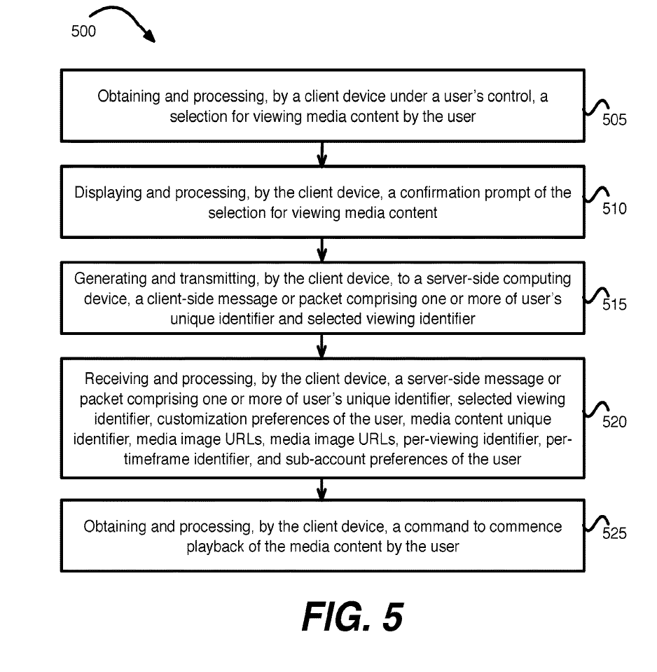

FIG. 5 is a flowchart of a method for viewing per-viewing and per-timeframe purchase, license, rental, distribution and consumption of media content and product merchandise. FIG. 5 applies to the method viewed from the client side.

The order of the steps in method 500 is not constrained to that shown in FIG. 5 or described in the following discussion. Several of the steps could occur in a different order without affecting the final result.

According to this method, the client-side electronic commerce application in the client device initiates viewing of media content with the server-side electronic commerce application in the server computing device.

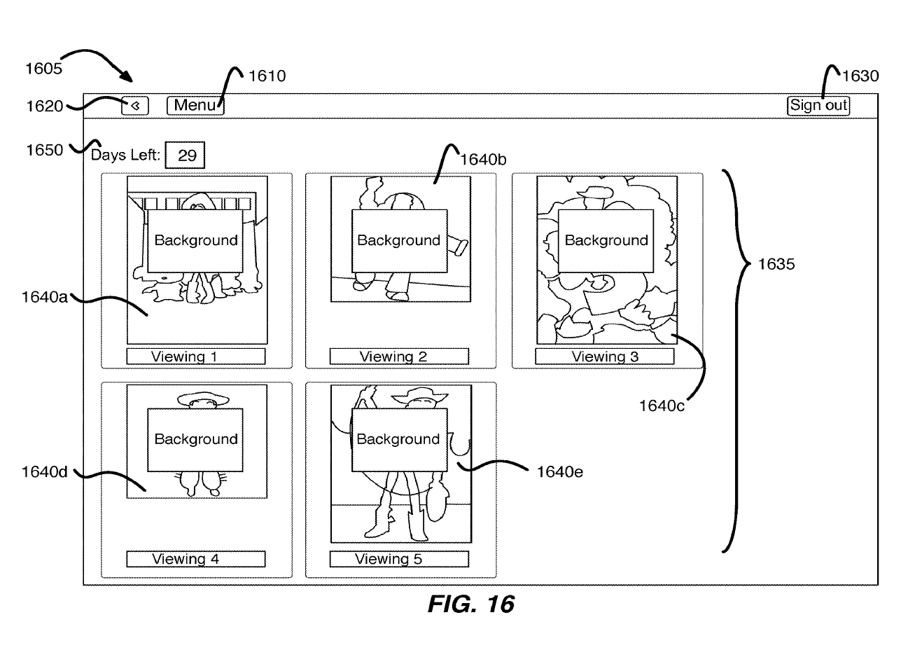

In block 505, the client-side electronic commerce application receives a command comprising user's selection for viewing media content. For example, the command comprises one or more of media content unique identifier and an other identifier. For example, the command may be performed by pressing one or more of the images displayed, a media image URL, a hyperlink, a button and a tab by the user such as may be given in FIG. 16. Block 505 then transfers control to block 510.

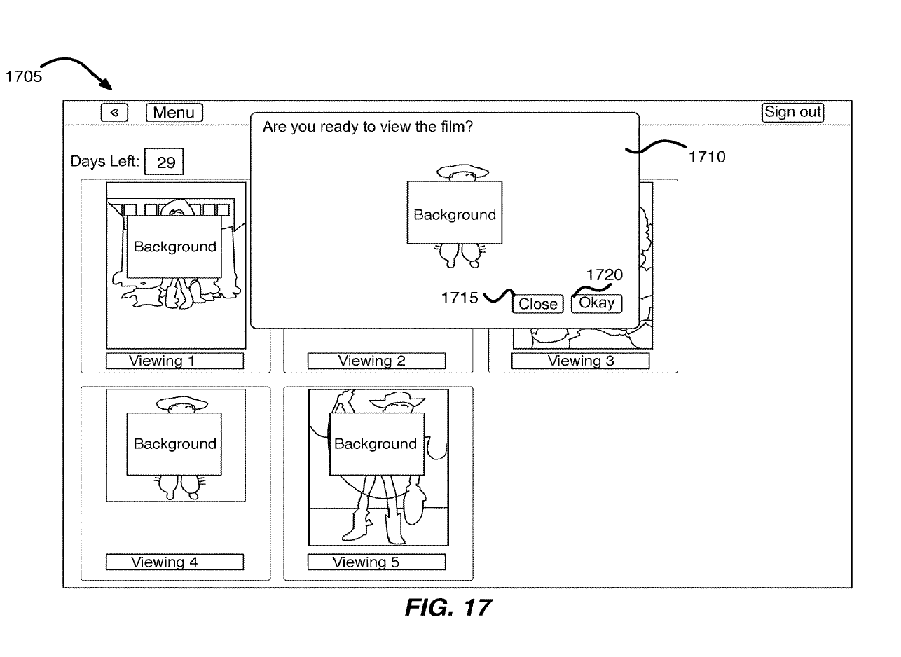

Next, in block 510, the client-side electronic commerce application displays a selection confirmation prompt to verify the initiation of viewing of media content. For example, a selection for viewing media content may be accepted or declined via the selection confirmation prompt by pressing one or more of an image, hyperlink, button or tab on the selection confirmation prompt such as may be given in FIG. 17. If the selection confirmation is declined by pressing, for example, a decline button, the process loops back to step 505.

If the selection confirmation is accepted by pressing, for example, an accept button, block 510 then transfers to block 515.

Next, in block 515, the client-side electronic commerce application sends a message or packet to the server-side electronic commerce application one or more of the user's unique identifier and selected viewing identifier. Block 515 then transfers control to block 520.

Next, in block 520, the client-side electronic commerce application receives from the server-side electronic commerce application a message or packet comprising one or more of user's unique identifier, selected viewing identifier, customization preferences of the user, media content unique identifier, media image URLs, media content URLs, per-viewing identifier, per-timeframe identifier, sub-account preferences of the user, and an other media content view information.

Optionally, or additionally, the client-side electronic commerce application receives from the server-side tracking application a notification that per-viewing allowance for subsequent viewings of the media content available are reduced by a pre-determined amount of viewings. Alternatively or additionally, in the case of a download of the media content ordered by the user, the client-side electronic application may receive an instruction from the server-side electronic commerce application to delete the media content ordered by the user. Block 520 then transfers control to block 525.

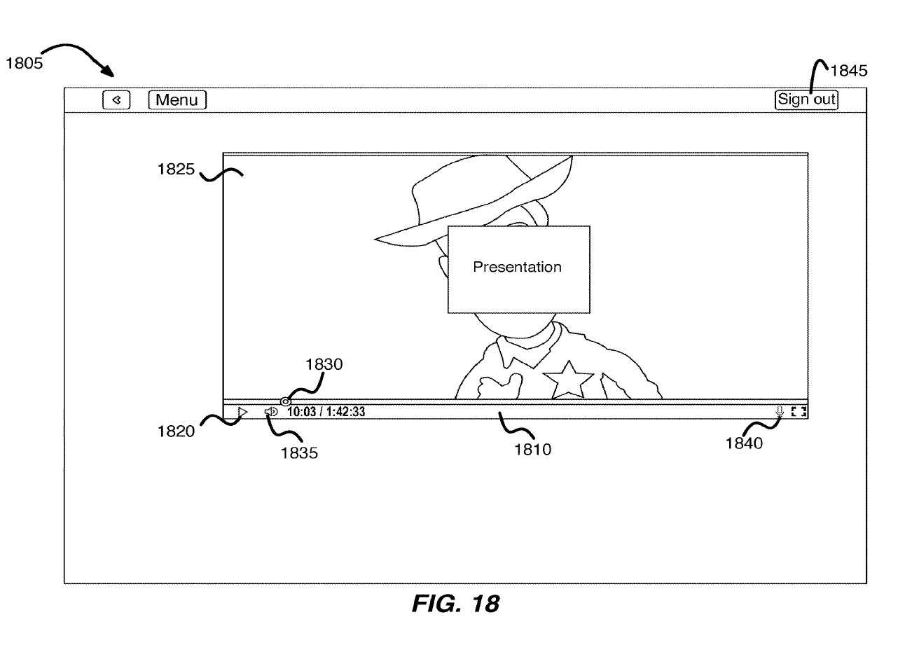

Next, in block 525, the client-side electronic application receives a command to commence playback of the selected media content for viewing. For example, a command to commence playback may be performed by pressing a play button on a client-side playback device such as may be given in FIG. 18. The client-side electronic commerce application then commences playback of the selected media content for viewing. Block 525 then terminates the process.

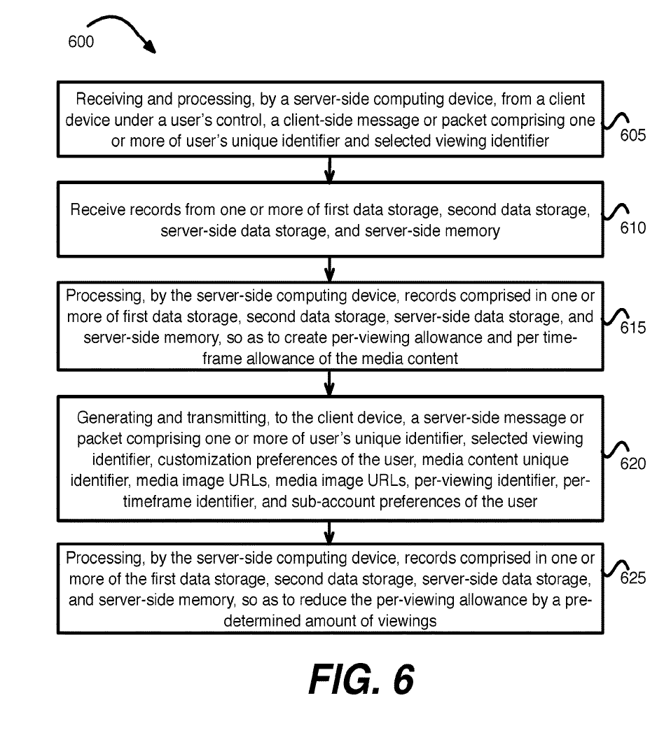

FIG. 6 is a flowchart of a method for viewing per-viewing and per-timeframe purchase, license, rental, distribution and consumption of media content and product merchandise. FIG. 6 applies to the method viewed from the server side.

The order of the steps in method 600 is not constrained to that shown in FIG. 6 or described in the following discussion. Several of the steps could occur in a different order without affecting the final result.

According to this method, the client-side electronic commerce application in the client device initiates viewing of media content with the server-side electronic commerce application in the server computing device.

In block 605, the server-side electronic commerce application receives and processes a client-side message or packet comprising one or more of user's unique identifier and selected viewing identifier. Block 605 then transfers control to block 610.

Next, in block 610, the server-side electronic commerce application, using the server-side tracking application, queries one or more of first data storage, second data storage, server-side data storage and server-side memory to correspond particular search parameters using one or more of user's unique identifier and selected viewing identifier. If the query results do not correspond within the particular search parameters, the server-side electronic commerce application sends an error code to the client-side electronic commerce application, then the process loops back to step 605.

If the query results do correspond within the particular search parameters, the server-side tracking application receives from one or more of first data storage, second data storage, server-side data storage and server-side memory one or more results of the query. For example, the server-side tracking application may receive one or more records of one or more fields of user's unique identifier, customization preferences of the user, media content unique identifier, media image URLs, media content URLs, per-viewing identifier, per-timeframe identifier, sub-account preferences of the user, and an other media content view information. Block 610 then transfers control to block 615.

Next, in block 615, the server-side tracking application processes the results of the query. For example, the processing of the query comprises the verification that the per-timeframe identifier value is greater than zero, and subsequently that the per-viewing identifier value is greater than zero. For example, one or more of per-viewing allowance and per-timeframe allowance for a media content to be consumed may be for a pre-determined amount of viewings within a pre-determined time span. For example, the media content to be consumed may be restricted by an other criteria than for one or more of per-viewing allowance and per-timeframe allowance.

If the processing of the query does not verify that per-timeframe identifier value is greater than zero, and subsequently that per-viewing identifier value is greater than zero, then the server-side tracking application sends to the client-side electronic commerce application a notification that the verification has been declined, then the process loops back to step 605.

If the processing of the query verifies that per-timeframe identifier value is greater than zero, and subsequently that per-viewing identifier value is greater than zero, then block 615 transfers control to block 620.

Next, in block 620, the server-side tracking application sends to the client-side electronic commerce application a message or packet comprising one or more of user's unique identifier, selected viewing identifier, customization preferences of the user, media content unique identifier, media images URLs, media content URLs, per-viewing identifier, per-timeframe identifier, sub-account preferences of the user, and an other media content view information. Block 620 then transfers control to block 625

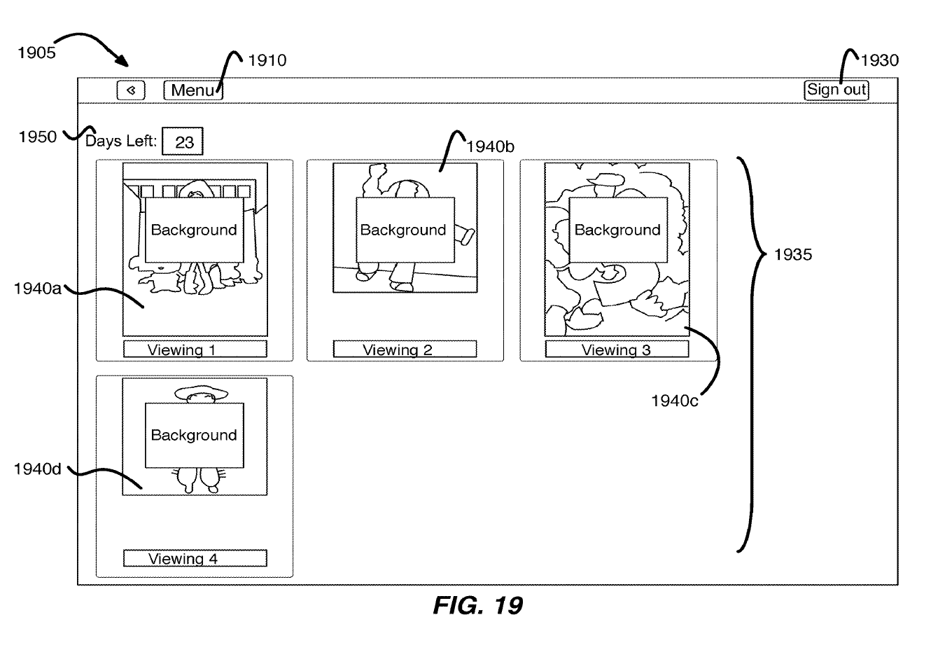

Next, in block 625, the server-side tracking application reduces the per-viewing allowance by a pre-determined amount of viewings. For example, if the per-viewing time allowance was for five viewings of the media content, and the pre-determined amount of reduction is one viewing of the media content, then the server-side tracking application reduces the per-viewing allowance for subsequent viewings of the media content available from five viewings to four viewings, such as may be given in FIG. 19.

In another embodiment, the server-side tracking application may instruct one or more of the first data storage, the second data storage, the server-side data storage and the server-side memory to delete media content ordered by the user. Optionally, or additionally, the server-side tracking application sends a notification to the client-side electronic commerce application that per-viewing allowance for subsequent viewings of the media content available are reduced by a pre-determined amount of viewings. Alternatively or additionally, in the case of a download of the media content ordered by the user, the server-side electronic commerce application sends to the client-side electronic application an instruction to delete the media content ordered by the user. Block 825 then terminates the process.

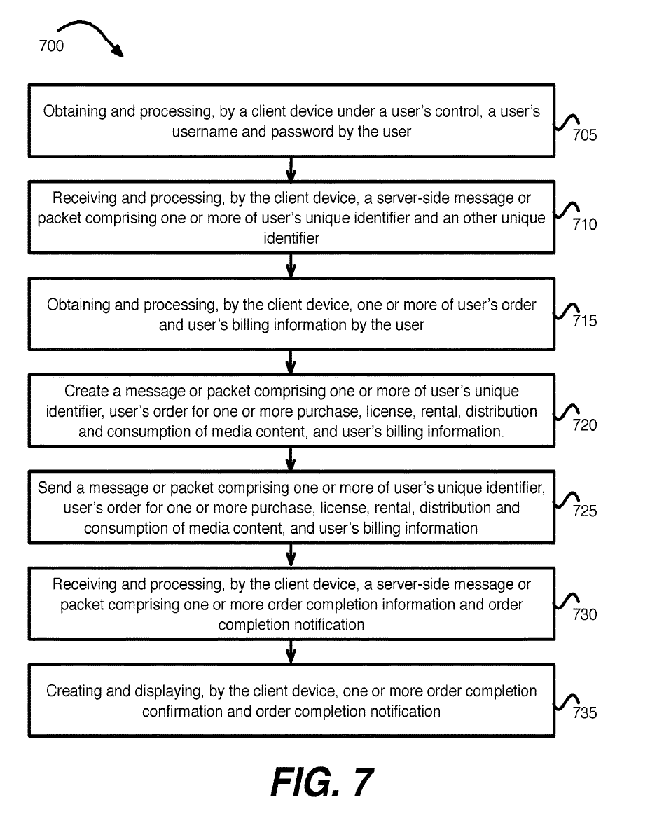

FIG. 7 is a flowchart of a method for transacting per-viewing and per-timeframe purchase, license, rental, distribution and consumption of media content and product merchandise. FIG. 7 applies to the method viewed from the client side.

The order of the steps in the method 700 is not constrained to that shown in FIG. 7 or described in the following discussion. Several of the steps could occur in a different order without affecting the final result.

According to this method, the client-side electronic commerce application in the client device initiates purchase of media content with the server-side electronic commerce application in the server computing device.

In block 705, a client-side electronic commerce application receives from a client device under a user's control and processes one or more of user's username and password. For example, user's username and password may access one or more of a previously registered account and a new account created by the user. For example, an account may comprise one or more of user's username and password, user's historical purchases, sub-account's historical purchases, user's consumption history, sub-account's consumption history, and an other form of account information. For example, user's username and password provide a pre-requisite before a client device may gain access to one or more of the client-side electronic commerce application and the server-side electronic commerce application. The client-side electronic commerce application then sends one or more of user's username and password to the server-side electronic commerce application. FIG. 13 provides more detail regarding sub-steps of step 705 in FIG. 7. Block 705 then transfers control to block 310.

Next, in block 710, the client-side electronic commerce application receives from the server-side electronic commerce application and processes a message or packet comprising one or more of user's unique identifier and an other unique identifier. For example, user's unique identifier accesses one or more of a previously registered account and a new account created by a user. For example, an other unique identifier may comprise one or more of fingerprint image, security code, and an other unique identifier. Block 710 then transfers control to block 715.

Next, in block 715, the client-side electronic commerce application receives one or more of user's order for one or more of purchase, license, rental, distribution and consumption of media content, and user's billing information. For example, user's order for one or more of purchase, license, rental, distribution and consumption of media content may comprise one or more of media content, user's selection of media content, customized media content, customization preferences of the user, sub-account preferences of the user, and an other form of order information. For example, user's billing information comprises one or more of credit card account number, debit account number, CVC number, another form of security identifier, account expiration year, account expiration month, account pin number, and an other form of billing information. Block 715 then transfers control to block 720.

Next, in block 720, the client-side electronic commerce application creates a message or packet comprising one or more of user's unique identifier, user's order for one or more of purchase, license, rental, distribution and consumption of media content, and user's billing information. Block 720 then transfers control to block 725.

Next, in block 725, the client-side electronic commerce application sends to the server-side electronic commerce application a message or packet comprising one or more of user's unique identifier, user's order for one or more purchase, license, rental, distribution and consumption of media content, and user's billing information. Block 725 then transfers control to block 730.

Next, in block 730, if the transaction is not executable, the client-side electronic commerce application receives a declined order notification from the server-side electronic commerce application. For example, a transaction may not be executable if the server-side electronic commerce application receives a notification of one or more of insufficient funds, account closed, no account, invalid account number, debit not authorized, bank ownership change, account frozen, bank account restricted, invalid currency, and another form of notification from one or more of external server and internal server. The process then loops back to step 705.

If the transaction is executable, the client-side electronic commerce application receives from the server-side electronic commerce application a message or packet comprising one or more of order completion confirmation and order completion notification. Block 730 then transfers to block 735.

Next, in block 735, the client-side electronic commerce application displays one or more of order completion confirmation on the client device under a user's control, and order completion notification to the user. For example, one or more of order completion confirmation and order completion notification may display a thank you for purchasing message, an acknowledgement of purchase message, a summary of purchase message, a billing receipt for the transaction, the unique playlist reference link so as to allow the user access to the media content ordered, one or more advertising and promotions of one or more of media content and product merchandise on offer to the user, the media content ordered by the user, and the like. For example, the user may receive order completion notification via a user's email address, SMS, street address mailing, and the like. For example, one or more of media content and product merchandise may be customized. For example, one or more of media content and product merchandise may not be customized. For example, one or more of media content and product merchandise may be related to the media content ordered by the user. For example, one or more of media content and product merchandise may be related to the user's consumption history. For example, one or more of media content and product merchandise may be related to a factor other than the media content ordered by the user and the user's consumption history. Block 735 then terminates the process.

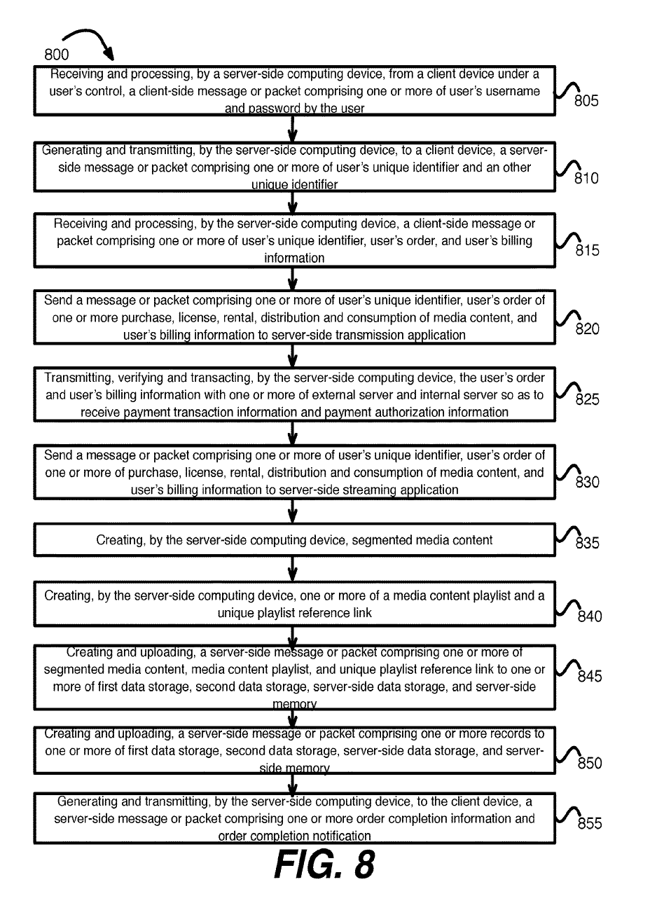

FIG. 8 is a flowchart of a method for transacting per-viewing and per-timeframe purchase, license, rental, distribution and consumption of media content and product merchandise. FIG. 8 applies to the method viewed from the server side.

The order of the steps in the method 800 is not constrained to that shown in FIG. 8 or described in the following discussion. Several of the steps could occur in a different order without affecting the final result.

According to this method, the client-side electronic commerce application in the client device initiates purchase of media content with the server-side electronic commerce application in the server computing device.

In block 805, the server-side electronic commerce application receives and processes a client-side message or packet comprising one or more of user's username and password. FIG. 14 provides more details regarding sub-steps of step 805 in FIG. 8. Block 805 then transfers control to block 810.

Next, in block 810, the server-side electronic commerce application sends the client-side electronic commerce application a message or packet comprising one or more of user's unique identifier and an other unique identifier. Block 810 then transfers control to block 815.

Next, in block 815, the server-side electronic commerce application receives from the client-side electronic commerce application and processes a message or packet comprising one or more of user's unique identifier, user's order of one or more purchase, license, rental, distribution and consumption of media content, and user's billing information. Block 815 then transfers control to block 820.

Next, in block 820, the server-side electronic commerce application sends a message or packet comprising one or more of user's unique identifier, user's order for one or more purchase, license, rental, distribution and consumption of media content, and user's billing information to the server-side transmission application. Block 820 then transfers control to block 825.

Next, in block 825, the server-side electronic commerce application, using the server-side transmission application, transmits a message or packet of one or more of user's unique identifier, user's order for one or more purchase, license, rental, distribution and consumption of media content, and user's billing information to one or more of an external server and an internal server so as to one or more verify and transact the user's order and billing information. For example, the server-side transmission application may communicate via an external service a financial provider's one or more of application programming interface API and software development kits SDK. For example, a service financial provider may be one or more of payment gateway company, financial institution, and the like. If the transaction is not executable, the server-side electronic commerce application sends a declined order notification to the client-side electronic commerce application. For example, a transaction may not be executable if the server-side electronic commerce application receives a notification of one or more of insufficient funds, account closed, no account, invalid account number, debit not authorized, bank ownership change, account frozen, bank account restricted, invalid currency, and another form of notification from one or more of external server and internal server. The process then loops back to step 805.

If the transaction is executable, the server-side electronic commerce application receives from one or more of external server and internal server one or more payment transaction information and payment authorization information. For example, payment transaction information comprises currency type. For example, payment transaction information may comprise alternative and additional information types to facilitate the receipt of a payment method. For example, payment authorization information may comprise one or more of token identification and an other form of payment authorization.

Alternatively, or additionally, block 825 may be performed using one or more of frictionless billing and payment applications and services without requiring a user to input billing information for an individual transaction. For example, frictionless applications and services may comprise billing and payment transmittal absent a physical transaction such as may be made with a physical credit card transaction. For example, frictionless applications and services may utilize near-field communication technology (NFC) that allows two devices within range of each other to exchange data. For example, frictionless applications and services may comprise an other form of frictionless method for billing and payment transactions other than one or more of absent a physical transaction and NFC technology. Block 825 then transfers control to block 830.

Next, in block 830, the server-side electronic commerce application sends a message or packet comprising one or more of user's unique identifier, user's order for one or more purchase, license, rental, distribution and consumption of media content, and user's billing information to the server-side streaming application. Block 830 then transfers control to block 835.

Next, in block 835, the server-side electronic commerce application, using the server-side streaming application, segments the media content ordered by the user. Block 835 then transfers control to block 840.

Next, in block 840, the server-streaming application creates one or more of playlist of the media content ordered by the user and unique playlist reference link. For example, unique playlist reference link may comprise of one or more of one or more of an internet web address, hyperlink, and URL. Block 840 then transfers control to block 845.

Next, in block 845, the server-side streaming application uploads to one or more of first data storage, second data storage, server-side data storage, and server-side memory one or more of segmented media content ordered by the user, playlist of the media content ordered by the user, and unique playlist reference link. For example, the server-side streaming application may upload one or more of segmented media content ordered by the user, playlist of the media content ordered by the user, and unique playlist reference link using one or more of a serial algorithm and a parallel algorithm. Block 845 then transfers control to block 850.

In another embodiment, step 845 may be performed by the server-side streaming application chunking segmented media content into downloadable sections to initiate downloading directly to the client device.

Next, in block 850, the server-side streaming application, using the server-side transmission application, uploads to one or more of first data storage, second data storage, server-side data storage, and server-side memory one or more records that comprise at least one field. For example, a field may comprise content associated with one or more of geographical location, date, media content title, media content transaction date, user's unique identifier, unique playlist reference link, media transaction price, per-viewing allowance amount, per-timeframe allowance amount, user's customized selections, user's billing information, images, and an other field content. Block 850 then transfers control to block 855.

Next, in block 855, the server-side electronic commerce application sends a message or packet comprising one or more of order completion confirmation and order completion notification to the client-side electronic commerce application. Block 855 then terminates the process.

FIG. 9 is a flowchart of a method for transacting a sub-account per-viewing and per-timeframe purchase, license, rental, distribution and consumption of media content and product merchandise. FIG. 9 applies to the method viewed from the client side.

The order of the steps in method 900 is not constrained to that shown in FIG. 9 or described in the following discussion. Several of the steps could occur in a different order without affecting the final result.

According to this method, the client-side electronic commerce application in the client device creates sub-account of the user of media content with the server-side electronic commerce application in the server computing device.

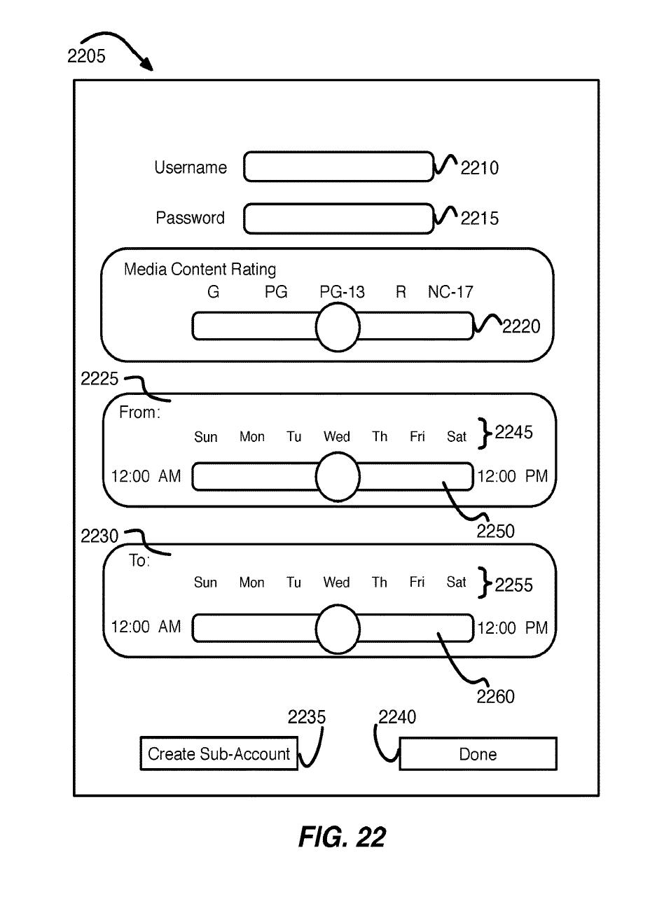

In block 905, the client-side electronic commerce application receives and processes one or more of sub-account and sub-account preferences. For example, sub-account may comprise one or more alternative or additional username and password to that of the user's username and password. For example, sub-account preferences may comprise one or more alternative and additional per-viewing criteria to that of the customized preferences of the user. For example, the sub-account preferences may set per-viewing criteria so as to one or more include and exclude one or more of particular content rating, interval viewable, and an other basis for per-viewing criteria. For example, the sub-account content rating may comprise one or more of a local API or third party API application. For example, a content rating may comprise one or more of a rating by the Motion Picture Association of America, a violence content advisory level, a TV Parental Guideline, a sexual content advisory, and an other rating of the media content. For example, interval viewable for sub-account may set parameters so as to one or more include and exclude per-viewing between the hours of 4:00 pm and 11:59 pm. For example, interval viewable for a sub-account may set parameters so as to one or more include and exclude per-viewing between hours other than between the hours of 4:00 pm and 11:59 pm. The client-side electronic commerce application then sends one or more of the user's unique identifier, a media content unique identifier, sub-account and sub-account preferences to the server-side electronic commerce application. FIG. 13 and FIG. 22 provide more detail regarding sub-steps of step 905 in FIG. 9.

Optionally, or additionally, the client-side electronic commerce application receives and processes one or more of kids sub-account and kids sub-account preferences. For example, kids sub-account may comprise one or more alternative or additional username and password to that of the user's username and password. For example, kids sub-account preferences may comprise one or more alternative and additional per-viewing criteria to that of the customized preferences of the user. For example, the kids sub-account preferences may set per-viewing criteria so as to one or more include and exclude one or more of pre-defined rating, pre-defined advertisements, and the like. For example, the pre-defined rating may comprise that of the Motion Picture Association of America rating for General (“G”) rated audiences. For example, the pre-defined advertisements may comprise limiting parameters that conform to legal restrictions for advertising to children audience programming. Block 905 then transfers control to block 910.

Next, in block 910, the client-side electronic commerce application receives from the server-side electronic commerce application and processes a message or packet comprising one or more of one or more of user's unique identifier and an other unique identifier unique. For example, a user's unique identifier accesses one or more of a previously registered account and a new account created by a user. For example, an other unique identifier may comprise one or more of fingerprint image, security code, and an other unique identifier. Block 910 then transfers control to block 915.

Next, in block 915, the client-side electronic commerce application receives one or more of sub-account order for one or more of purchase, license, rental, distribution and consumption of media content, and user's billing information. For example, sub-account order for one or more of purchase, license, rental, distribution and consumption of media content may comprise one or more of media content, sub-account selection of media content, customized media content, customization preferences of the user, sub-account preferences of the user, and an other form of order information. For example, user's billing information comprises one or more of credit card account number, debit account number, CVC number, another form of security identifier, account expiration year, account expiration month, account pin number, and an other form of billing information. Block 915 then transfers control to block 920.

Next, in block 920, the client-side electronic commerce application creates a message or packet comprising one or more of user's unique identifier, sub-account order for one or more of purchase, license, rental, distribution and consumption of media content, and user's billing information. Block 920 then transfers control to block 925.

Next, in block 925, the client-side electronic commerce application sends to the server-side electronic commerce application a message or packet comprising one or more of user's unique identifier, sub-account order for one or more purchase, license, rental, distribution and consumption of media content, and user's billing information. Block 925 then transfers control to block 930.

Next, in block 930, if the transaction is not executable, the client-side electronic commerce application receives a declined order notification from the server-side electronic commerce application. For example, a transaction may not be executable if the server-side electronic commerce application receives a notification of one or more of insufficient funds, account closed, no account, invalid account number, debit not authorized, bank ownership change, account frozen, bank account restricted, invalid currency, and another form of notification from one or more of external server and internal server. The process then loops back to step 905.

If the transaction is executable, the client-side electronic commerce application receives from the server-side electronic commerce application a message or packet comprising one or more of order completion confirmation and order completion notification. Block 930 then transfers to block 935.

Next, in block 935, the client-side electronic commerce application displays one or more of order completion confirmation on the client device under a user's control, and order completion notification to the user. For example, one or more of order completion confirmation and order completion notification may display a thank you for purchasing message, an acknowledgement of purchase message, a summary of purchase message, a billing receipt for the transaction, the unique playlist reference link so as to allow the sub-account access to the media content ordered, one or more advertising and promotions of one or more of media content and product merchandise on offer to the sub-account, the media content ordered by the sub-account, and the like. For example, the user may receive order completion notification via a user's email address, SMS, street address mailing, and the like. For example, one or more of media content and product merchandise may be customized. For example, one or more of media content and product merchandise may not be customized. For example, one or more of media content and product merchandise may be related to the media content ordered by the sub-account. For example, one or more of media content and product merchandise may be related to the sub-account's consumption history. For example, one or more of media content and product merchandise may be related to a factor other than the media content ordered by the sub-account and the sub-account's consumption history. Block 935 then terminates the process.

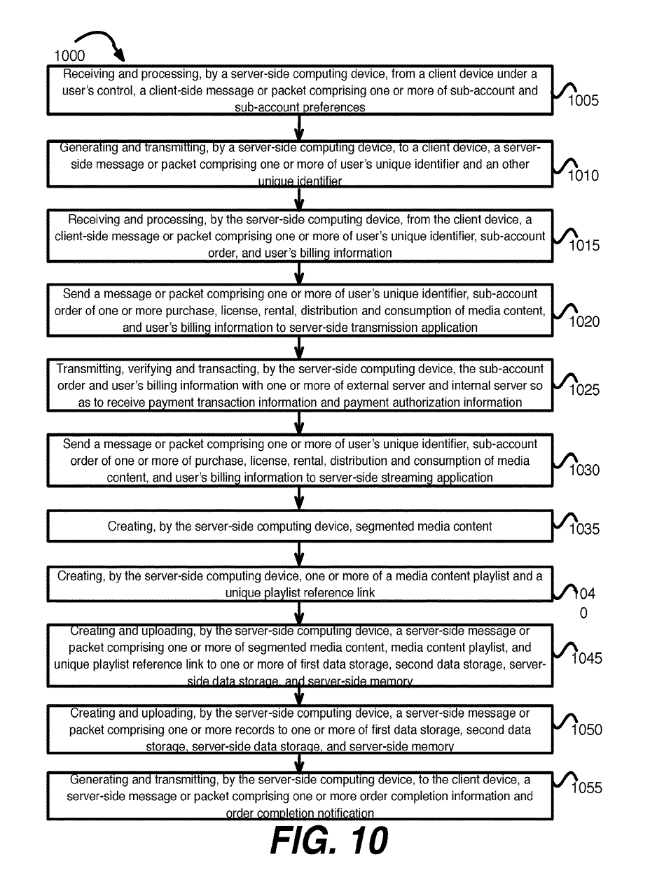

FIG. 10 is a flowchart of a method for transacting a sub-account per-viewing and per-timeframe purchase, license, rental, distribution and consumption of media content and product merchandise. FIG. 10 applies to the method viewed from the server side.

The order of the steps in method 1000 is not constrained to that shown in FIG. 10 or described in the following discussion. Several of the steps could occur in a different order without affecting the final result.

According to this method, the client-side electronic commerce application in the client device creates sub-account of the user of media content with the server-side electronic commerce application in the server computing device.

In block 1005, the server-side electronic commerce application receives and processes a client-side message or packet comprising one or more of sub-account and sub-account preferences. FIG. 14 and FIG. 22 provide more detail regarding sub-steps of step 1005 in FIG. 10. Block 1005 then transfers control to block 1010.

Next, in block 1015, the server-side electronic commerce application receives from the client-side electronic commerce application and processes a message or packet comprising one or more of user's unique identifier, sub-account order of one or more purchase, license, rental, distribution and consumption of media content, and user's billing information. Block 1015 then transfers control to block 1020.

Next, in block 1020, the server-side electronic commerce application sends a message or packet comprising one or more of user's unique identifier, sub-account order for one or more purchase, license, rental, distribution and consumption of media content, and user's billing information to the server-side transmission application. Block 1020 then transfers control to block 1025.

Next, in block 1025, the server-side electronic commerce application, using the server-side transmission application, transmits a message or packet of one or more of user's unique identifier, sub-account order for one or more purchase, license, rental, distribution and consumption of media content, and user's billing information to one or more of an external server and an internal server so as to one or more verify and transact the user's order and billing information. For example, the server-side transmission application may communicate via an external service a financial provider's one or more of application programming interface API and software development kits SDK. For example, a service financial provider may be one or more of payment gateway company, financial institution, and the like. If the transaction is not executable, the server-side electronic commerce application sends a declined order notification to the client-side electronic commerce application. For example, a transaction may not be executable if the server-side electronic commerce application receives a notification of one or more of insufficient funds, account closed, no account, invalid account number, debit not authorized, bank ownership change, account frozen, bank account restricted, invalid currency, and another form of notification from one or more of external server and internal server. The process then loops back to step 1005.

If the transaction is executable, the server-side electronic commerce application receives from one or more of external server and internal server one or more payment transaction information and payment authorization information. For example, payment transaction information comprises currency type. For example, payment transaction information may comprise alternative and additional information types to facilitate the receipt of a payment method. For example, payment authorization information may comprise one or more of token identification and an other form of payment authorization.

Alternatively, or additionally, block 1025 may be performed using one or more of frictionless billing and payment applications and services without requiring a user to input billing information for an individual transaction. For example, frictionless applications and services may comprise billing and payment transmittal absent a physical transaction such as may be made with a physical credit card transaction. For example, frictionless applications and services may utilize near-field communication technology (NFC) that allows two devices within range of each other to exchange data. For example, frictionless applications and services may comprise an other form of frictionless method for billing and payment transactions other than one or more of absent a physical transaction and NFC technology. Block 1025 then transfers control to block 1030.

Next, in block 1030, the server-side electronic commerce application sends a message or packet comprising one or more of user's unique identifier, sub-account order for one or more purchase, license, rental, distribution and consumption of media content, and user's billing information to the server-side streaming application. Block 1030 then transfers control to block 1035.

Next, in block 1035, the server-side electronic commerce application, using the server-side streaming application, segments the media content ordered by the sub-account. Block 1035 then transfers control to block 1040.

Next, in block 1040, the server-streaming application creates one or more of playlist of the media content ordered by the sub-account and unique playlist reference link. For example, unique playlist reference link may comprise of one or more of one or more of an internet web address, hyperlink, and URL. Block 1040 then transfers control to block 1045.

Next, in block 1045, the server-side streaming application uploads to one or more of first data storage, second data storage, server-side data storage, and server-side memory one or more of segmented media content ordered by the sub-account, playlist of the media content ordered by the sub-account, and unique playlist reference link. For example, the server-side streaming application may upload one or more of segmented media content ordered by the sub-account, playlist of the media content ordered by the sub-account, and unique playlist reference link using one or more of a serial algorithm and a parallel algorithm. Block 1045 then transfers control to block 1050.

In another embodiment, step 1045 may be performed by the server-side streaming application chunking segmented media content into downloadable sections to initiate downloading directly to the client device.

Next, in block 1050, the server-side streaming application, using the server-side transmission application, uploads to one or more of first data storage, second data storage, server-side data storage, and server-side memory one or more records that comprise at least one field. For example, a field may comprise content associated with one or more of geographical location, date, media content title, media content transaction date, user's unique identifier, unique playlist reference link, media transaction price, per-viewing allowance amount, per-timeframe allowance amount, user's customized selections, user's billing information, images, and an other field content. Block 1050 then transfers control to block 1055.

Next, in block 1055, the server-side electronic commerce application sends a message or packet comprising one or more of order completion confirmation and order completion notification to the client-side electronic commerce application. Block 1055 then terminates the process.

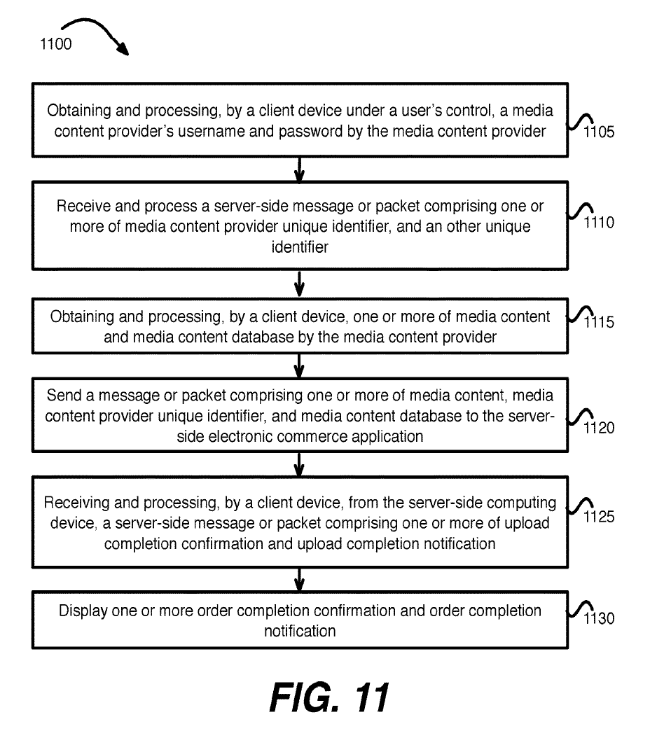

FIG. 11 is a flowchart of a method for uploading provider media content for per-viewing and per-timeframe purchase, license, rental, distribution and consumption of media content and product merchandise. FIG. 11 applies to the method from the client side.

The order of the steps in the method 1100 is not constrained to that shown in FIG. 11 or described in the following discussion. Several of the steps could occur in a different order without affecting the final result.

According to this method, the client-side electronic commerce application in the client device uploads media content to the server-side electronic commerce application in the server computing device.

In block 1105, a client-side electronic commerce application receives media content provider's username and password. FIG. 13 provides more details regarding sub-steps of step 1105 in FIG. 11. For example, media content provider comprises one or more of filmmaker, motion picture production company, animation production company, broadcast television production company, pay television production company, advertising company, major motion picture distributor, an other motion picture distributor, a talent agency, and an other media content provider. The client-side electronic commerce application then sends a message or packet comprising one or more of media content provider username and password to the server-side electronic commerce application. Block 1105 then transfers control to block 1110.

Next, in block 1110, the client-side electronic commerce application receives from the server-side electronic commerce application and processes a message or packet comprising one or more of media content provider unique identifier and an other unique identifier. Block 1110 then transfers control to block 1115.

Next, in block 1115, the client-side electronic commerce application receives and processes a message or packet comprising one or more of media content and media content database. For example, media content provider provides media content available for one or more of purchase, license, rental, distribution and consumption. For example, the media content provider provides media content available for one or more of venue, public, office, home, and an other environment. For example, the media content database comprises one or more records of one or more fields comprising values selected by one or more of media content provider, venue, public, office, home, and an other environment.

The records comprise values for one or more of the media content unique identifier, media image URLs, media content URLs, per-viewing identifier, per-timeframe identifier, and an other media content view information. For example, fields may comprise values for one or more of geographical location, date, media content title, media content transaction date, user's unique identifier, unique playlist reference link, media transaction price, per-viewing allowance, per-timeframe allowance, user's customized selections, user's billing information, images, audio media content, video media content, text, audio effects, visual effects, an internet web address, a hyperlink, a media content URL, and an other field information. Block 1115 then transfers control to block 1120.

Next, in block 1120, the client-side electronic commerce application sends to the server-side electronic commerce application a message or packet comprising one or more of media content, media content provider unique identifier and media content database. Block 1120 then transfers control to block 1125.

Next, in block 1125, the client-side electronic application receives and processes a message or packet from the server-side electronic commerce application comprising one or more upload completion confirmation and upload completion notification. If the media content database is not uploaded, the client-side electronic commerce application receives from the server-side electronic commerce application an error code, and the process loops back to 1105. Block 1125 then transfers control to block 1130.

Next, in block 1130, the client-side electronic commerce application displays one or more of upload completion confirmation on the client device under a media content provider's control, and order completion notification to the media content provider. For example, one or more of upload completion confirmation and upload completion notification may display a thank you for uploading message, an acknowledgement of upload message, a summary of upload message, a billing receipt for the transaction, the unique playlist reference link so as to allow the media content provider access to the media content uploaded, one or more advertising and promotions of one or more of media content and product merchandise on offer to the media content provider, and the like. For example, the media content provider may receive order completion notification via media content provider's email address, SMS, street address mailing, and the like. Block 1130 then terminates the process.

In another embodiment, media content provider may submit on one or more of a limited basis and perpetual basis one or more of data to the database. For example, media content provider may one or more add, delete and alter data the database so as to modify one or more of records and fields. For example, media content provider may one or more accept and decline access to media content by populating the geographic location field. For example, media content provider may decline access of media content to users outside of the United States and Canada. For example, media content provider may decline access of media content to users other than those outside of the United States and Canada.

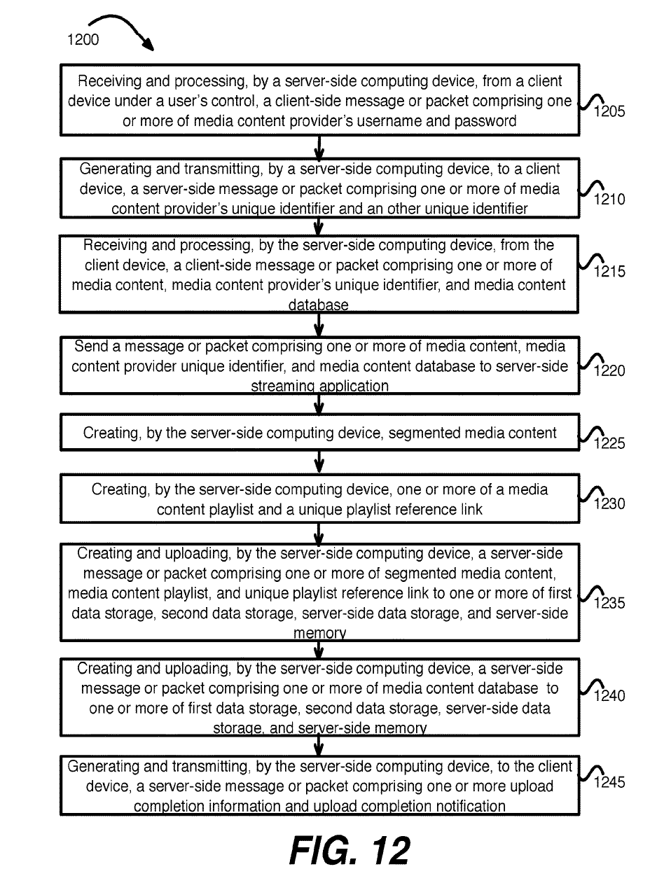

FIG. 12 is a flowchart of a method for uploading provider content for per-viewing and per-timeframe purchase, license, rental, distribution and consumption of media content and product merchandise. FIG. 12 applies to the method from the server side.

The order of the steps in the method 1200 is not constrained to that shown in FIG. 12 or described in the following discussion. Several of the steps could occur in a different order without affecting the final result.

According to this method, the client-side electronic commerce application in the client device uploads media content to the server-side electronic commerce application in the server computing device.

In block 1205, the server-side electronic commerce application receives and processes a client-side message or packet comprising one or more of media content provider's username and password. FIG. 14 provides more details regarding sub-steps of step 1205 in FIG. 12. Block 1205 then transfers control to block 1210.

Next, in block 1210, the server-side electronic commerce application sends the client-side electronic commerce application a message or packet comprising one or more of media content provider unique identifier and an other unique identifier. Block 1210 then transfers control to block 1215.

Next, in block 1215, the server-side electronic commerce application receives from the client-side electronic commerce application and processes a message or packet comprising one or more of media content, media content provider unique identifier, and media content database. Block 1215 then transfers control to block 1220.

Next, in block 1220, the server-side electronic commerce application sends a message or packet comprising one or more of media content, media content provider unique identifier, and media content database to the server-side streaming application. Block 1220 then transfers control to block 1225.

Next, in block 1225, the server-side electronic commerce application, using the server-side streaming application, segments the media content. Block 1225 then transfers control to block 1230.

Next, in block 1230, the server-streaming application creates one or more of playlist of the media content and unique playlist reference link. For example, unique playlist reference link may comprise of one or more of one or more of an internet web address, hyperlink, and URL. Block 1230 then transfers control to block 1235.

Next, in block 1235, the server-side streaming application uploads to one or more of first data storage, second data storage, server-side data storage, and server-side memory one or more of segmented media content, playlist of the media content, and unique playlist reference link of media content. For example, the server-side streaming application may upload one or more of segmented media content, playlist of the media content, and unique playlist reference link using one or more of a serial algorithm and a parallel algorithm. Block 1235 then transfers control to block 1240.

In another embodiment, step 1235 may be performed by the server-side streaming application chunking segmented media content into downloadable sections.

Next, in block 1240, the server-side streaming application, using the server-side transmission application, uploads to one or more of first data storage, second data storage, server-side data storage, and server-side memory one or more media content database. Block 1240 then transfers control to block 1245.

Next, in block 1245, the server-side electronic commerce application sends a message or packet comprising one or more of upload completion confirmation and upload completion notification to the client-side electronic commerce application. Block 1245 then terminates the process.

FIG. 13 is a flowchart of a method for authenticating per-viewing and per-timeframe purchase, license, rental, distribution and consumption of media content and product merchandise. FIG. 13 applies to the method viewed from the client side.

The order of the steps in the method 1300 is not constrained to that shown in FIG. 13 or described in the following discussion. Several of the steps could occur in a different order without affecting the final result.

According to this method, the client-side electronic commerce application in the client device initiates a connection to the server-side electronic commerce application in the server computing device.

In block 1305, a client-side electronic commerce application receives from a client device under a user's control and processes one or more of user's username and password. For example, user's username and password may access one or more of a previously registered account and a new account created by the user. For example, an account may comprise one or more of user's username and password, user's historical purchases, sub-account's historical purchases, user's consumption history, sub-account's consumption history, and an other form of account information. For example, user's username and password provide a pre-requisite before a client device may gain access to one or more of the client-side electronic commerce application and the server-side electronic commerce application. Block 1305 then transfers control to block 1310.

Next, in block 1310, the client-side electronic commerce application creates a message or packet comprising one or more of user's username and password. Block 1310 then transfers control to block 1315.

Next, in block 1315, the client-side electronic commerce application sends a message or packet comprising one or more of the user's username and password to the server-side electronic commerce application. Block 1315 then transfers control to block 1320.

In another embodiment, the client-side electronic commerce application may restrict geo-location access by sending to the server-side electronic commerce application one or more of its client device unique identifier, internet protocol address (IP), and client device location. Alternatively or additionally, the client-side electronic commerce may force the use of a pre-determined Domain Name Server (DNS). For example, a pre-determined DNS may be one or more of Google DNS.

Next, in block 1320, if the user's username and password is not verified, the client-side electronic commerce application receives an error code from the server-side electronic commerce application, and the process loops back to 1305.

If the user's username and password is verified, the client-side electronic commerce application receives from the server-side electronic commerce application and processes a message or packet comprising one or more of a user's unique identifier and an other unique identifier. For example, user's unique identifier accesses one or more of a previously registered account and a new account created by a user. For example, an other unique identifier may comprise one or more of fingerprint image, security code, and an other unique identifier. Block 1320 then terminates the process.

FIG. 14 is a flowchart of a method for authenticating per-viewing and per-timeframe purchase, license, rental, distribution and consumption of one or more of media content and product merchandise. FIG. 14 applies to the method viewed from the server side.

The order of the steps in the method 1400 is not constrained to that shown in FIG. 14 or described in the following discussion. Several of the steps could occur in a different order without affecting the final result.

According to this method, the client-side electronic commerce application in the client device initiates a connection to the server-side electronic commerce application in the server computing device.

In block 1405, the server-side electronic commerce application receives a client-side message or packet comprising one or more of user's username and password from the client-side electronic commerce application. Block 1405 then transfers to block 1410.

In another embodiment, the server-side electronic commerce application receives one or more of client device unique identifier, IP address and client-device location information. The server-side electronic commerce application may then accept or deny access from the client-side electronic commerce application using corresponding pre-determined values. For example a pre-determined value may be one or more of an IP value.

Next, in block 1410, the server-side electronic commerce application sends a message or packet comprising one or more of user's username and password to the server-side data search application. Block 1410 then transfers control to block 1415.

Next, in block 1415, the server-side electronic commerce application, using the server-side data search application, queries one or more of first data storage, second data storage, server-side data storage and server-side memory to correspond particular search parameters using the user's username and password. If the query results do not correspond within particular search parameters, the server-side electronic commerce application sends an error code to the client-side electronic commerce application, then the process loops back to 1405.

If the query results do correspond within the particular search parameters, the server-side electronic commerce application sends the client-side electronic commerce application a message or packet comprising one or more of user's unique identifier and an other unique identifier. Block 1415 then terminates the process.

FIG. 15 is an exemplary screenshot of a graphical user interface (GUI) 1505 of a client device in a networked environment showing a screen initially displayed to a user prior to viewing per-viewing and per-timeframe purchase, license, rental, distribution and consumption of one or more of media content and product merchandise.

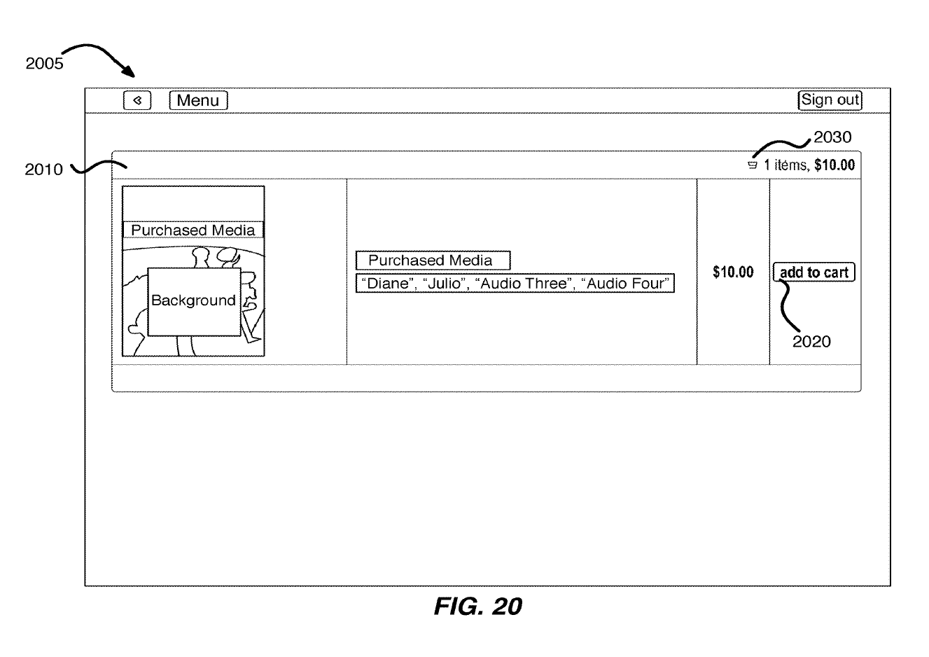

In FIG. 15, the media content options screenshot 1505 shows a tile display of the media content options the user will have. The user may be presented this Media Content Options screen 1505 when the user wishes to view one or more of media content available for purchase, license, rental, distribution and consumption, and media content previously purchased, licensed, rented, and distributed 1540c prior to consumption. The Media Content Options menu 1510 comprises Back button 1520, Buy button 1525, Sign Out button 1530, and Media Content list 1535. The Back button 1520 takes the user back to one or more of a login page, a home page, and an other page. The Buy button 1525 takes the user to an Item Purchase screen such as given in FIG. 20. The Sign Out button 1530 logs the user out from the application, then terminates the application.

The Media Content list 1535 as depicted comprises media content buttons 1540a-1540d. Media Content buttons 1540a-1540d offer the user the opportunity to view different media content. For example, the Media Content list 1535 lists media content that is one or more targeted to the user based on the user's account preferences and customization choices, and media content not targeted to the user based on the user's account and customization choices. The media content offered may be random. Alternatively, or additionally, the Media Content list 1535 lists product merchandise one or more targeted to the user based on the user's account preferences and customization choices, and product merchandise not targeted to the user based on a user's account preferences and customization choices. The product merchandise may be random. For example, product merchandise comprises one or more goods, services, and an other purchasable item. For example, the Media Content list 1535 lists one or more media content pre-determined by the venue. For example, the Media Content list 1535 lists one or more media content pre-determined by the distributor. For example, the Media Content list 1535 lists media content pre-determined by an other stakeholder other than the venue and distributor. For example, the Media Content list 1535 may list media content available at the venue. For example, the Media Content list 1535 may list media content not available at the venue. For example, the Media Content list 1535 lists media content operated by a third-party service provider. For example, the third-party provider may be a mall in which a multiplex rents space. For example, the media content may be audio-visual. For example, the media content may be audio only. For example, the media content may be previously produced. For example, the media content may be live-broadcasted or live-streamed. For example, the media content may be customized by the user. For example, the media content may not be customized by the user. For example, the product merchandise may be customized by the user. For example, the product merchandise may not be customized by the user.

In this particular example, the user is offered the opportunity to view a first motion picture using first media content button 1540a. In this particular example, the user is offered the opportunity to view a second motion picture using second media content button 1540b. In this particular example, the user is offered the opportunity to view a customized motion picture previously purchased using third media content button 1540c. In this particular example, the user is offered the opportunity to view a fourth motion picture using fourth media content button 1540d. For example, a selection to view a customized motion picture previously purchased by a user may be performed by pressing the third media content button 1540c from the Media Content list 1535. The user is then taken to the Media Content Viewing screen 1605 in FIG. 16.

FIG. 16 is an exemplary screenshot of a GUI 1605 of a client device in a networked environment that displays the viewings available to a user prior to selecting a first viewing of per-viewing and per-timeframe purchase, license, rental, distribution and consumption of one or more of media content and product merchandise.

In FIG. 16, the media content viewing options screenshot 1605 shows a tile display of the viewing options the user will have. The user may be presented this Media Content Viewing screen 1605 when the user wishes to view their purchased, licensed, rented and distributed media content after pressing the third media content button 1540c in FIG. 15. The Media Content Viewing menu 1610 comprises Back button 1620, Sign Out button 1630, Media Content Viewing list 1635, and Timeframe Counter 1650. The Back button 1620 takes the user back to one or more of a login page, a home page, and an other page. The Sign Out button 1630 logs the user out from the application, then terminates the application.

The Media Content Viewing list 1635 as depicted comprises media content viewing buttons 1640a-1640e. Media Content buttons 1640a-1640e offer the user the opportunity for five viewings of the customized motion picture previously purchased. For example, the Media Content Viewing list 1635 lists media content targeted to the user based on one or more of customization preferences of the user and sub-account preferences of the user. The user may choose any of the viewing buttons in which to initiate their next viewing. Alternatively, or additionally, the user may have their viewing choice limited to a particular order, such as a chronological order or an other serialized order. In this particular example, the user is offered the opportunity to view a customized motion picture viewing using first viewing button 1640a. In this particular example, the user is offered the opportunity to view a customized motion picture viewing using second viewing button 1640b. In this particular example, the user is offered the opportunity to view a customized motion picture viewing using third viewing button 1640c. In this particular example, the user is offered the opportunity to view a customized motion picture viewing using fourth viewing button 1640d. In this particular example, the user is offered the opportunity to view a customized motion picture viewing using fifth viewing button 1640e.

Timeframe Counter 1650 tracks the remaining timeframe allowance to the user for one or more viewings of media content. In this particular example, the user has 29 days remaining in which to view five viewings of the customized motion picture previously purchased. For example, the user has 29 days in which to view five viewings allotted to the user as evidenced by Timeframe Counter 1650, and the five tiles of viewing opportunities displayed. For example, the user has 29 days in which the user may view a first, second, third, fourth and fifth viewings of the media content purchased. For example, the timeframe may be given in minutes, hours, days, weeks, months and the like. For example, the timeframe may be given in an other unit measure other than minutes, hours, days, weeks, months and the like.

For example, a selection to view a customized motion pictured previously purchased by a user may be performed by pressing the fifth viewing button 1640e from the Media Content Viewing list 1635 to initiate a first viewing of a five viewing allowance. The user is then taken to the Viewing Selection screen 1705 in FIG. 17.

FIG. 17 is an exemplary screenshot of a GUI 1705 of a client device in a networked environment that displays a selection confirmation prompt to a user prior to consuming a viewing of per-viewing and per-timeframe purchase, license, rental, distribution and consumption of one or more of media content and product merchandise.

In FIG. 17, the selection confirmation screenshot 1705 shows Viewing Confirmation screen 1710 that prompts the user to confirm their desire to view a media content selection. If the user declines the viewing opportunity by, for example, pressing Close button 1715, the Viewing Confirmation screen 1710 loops back to Media Content Options menu 1510 in FIG. 15. If the viewer accepts the viewing opportunity by pressing, for example, the Okay button 1720, the user is then taken to the Media Content Player screen given in FIG. 18.

FIG. 18 is an exemplary screenshot of a GUI 1805 of a client device in a networked environment that displays an example of a player screen 1810. The Presentation 1825 comprises one or more of text, media, and another presentation format. Depicted in FIG. 18 is a screenshot of a customized character in a presentation. In this particular example, when a user presses a Play button 1820, a Presentation 1825 begins to play a customized motion picture previously purchased by the user in synchronization with a customized soundtrack. The Player slider 1830 allows the user to adjust what section of the presentation the user would like to watch. A Volume slider 1835 allows the user to adjust the audio volume. A Customization button 1840 allows the user to make real-time customization adjustments to the presentation being played. The Play button 1820 will switch its appearance to instead appear as a Stop button (not pictured) if the user indicates that they want to stop the playback by, for example, pressing on the Play button 1820. When the user wants to exit the player, the user presses the Sign Out button 1845.

FIG. 19 is an exemplary screenshot of a GUI 1905 of a client device in a networked environment that displays the viewings available to a user after consuming a first viewing and prior to selecting a second viewing of per-viewing and per-timeframe purchase, license, rental, distribution and consumption of media content.

In FIG. 19, the media content viewing options screenshot 1905 shows a tile display of the viewing options the user will have after consuming a first viewing. In this particular example, the user may be presented this Media Content Viewing screen 1905 when the user wishes a second viewing of their media content after pressing the third media content button 1540c in FIG. 15. The Media Content Viewing menu 1910 comprises Back button 1920, Sign Out button 1930, Media Content Viewing list 1935, and Timeframe Counter 1950. The Back button 1920 takes the user back to one or more of a login page, a home page, and an other page. The Sign Out button 1930 logs the user out from the application, then terminates the application.

The Media Content Viewing list 1935 comprises media content viewing buttons 1940a-1940d. Media Content buttons 1940a-1940d offer the user the opportunity for four viewings of the customized motion picture previously purchased. For example, the Media Content Viewing list 1935 lists media content targeted to the user based on one or more of customization preferences of the user and sub-account preferences of the user. The user may choose any of the viewing buttons in which to initiate their next viewing. In this particular example, the user is offered the opportunity to view a customized motion picture viewing using first viewing button 1940a. In this particular example, the user is offered the opportunity to view a customized motion picture viewing using second viewing button 1940b. In this particular example, the user is offered the opportunity to view a customized motion picture viewing using third viewing button 1940c. In this particular example, the user is offered the opportunity to view a customized motion picture viewing using fourth viewing button 1940d.

Timeframe Counter 1950 tracks the remaining timeframe allowance to the user for one or more viewings of media content. In this particular example, the user has 23 days remaining in which to view four viewings of the customized motion picture. For example, six days have elapsed since the 29 days the viewer consumed a first viewing of their customized motion picture as depicted in FIG. 16. For example, the user has 23 days in which to view four viewings allotted to the user as evidenced by Timeframe Counter 1950, and the four tiles of viewing opportunities displayed. For example, the user has 23 days in which the user may view a second, third, fourth and fifth viewings of the media content purchased. For example, the timeframe may be given in minutes, hours, days, weeks, months and the like. For example, the timeframe may be given in an other unit measure other than minutes, hours, days, weeks, months and the like.

For example, the user selects the fourth viewing button 1940d from the Media Content Viewing list 1935 to initiate a second viewing of the customized motion picture previously purchased by the user. The user is then taken to the Viewing Confirmation screen 1710 in FIG. 17.

FIG. 20 is an exemplary screenshot of a GUI 2005 of a client device in a networked environment that displays an Item Purchase Screen 2005 seen by a user purchasing additional viewings of per-viewing and per-timeframe purchase, license, rental, distribution and consumption of a customized media content previously purchased by the user.

Item Purchase Screen 2005 comprises Item Details field 2010 comprising information regarding the Item. For example, Item Details field 2010 comprises one or more of a photograph of the Item, a specification regarding the Item, an Item price, an Item condition, Item shipping information, Item manufacturer information, Item customer ratings, and an other Item detail. The photograph may be displayed in one or more of a static form, a scrolling form, and another photographic form. Optionally, Item Details field 2010 comprises one or more of text, media and another display format. Optionally, other items related to the selected item can also be displayed. In this particular example, the photograph of the customized motion picture previously purchased by the user is displayed in static form. If the user presses Add To Cart button 2020, additional items add to the Cart 2030. If the user presses on Cart button 2030, the user is then taken to a purchase summary screen to complete the transaction (not pictured.)

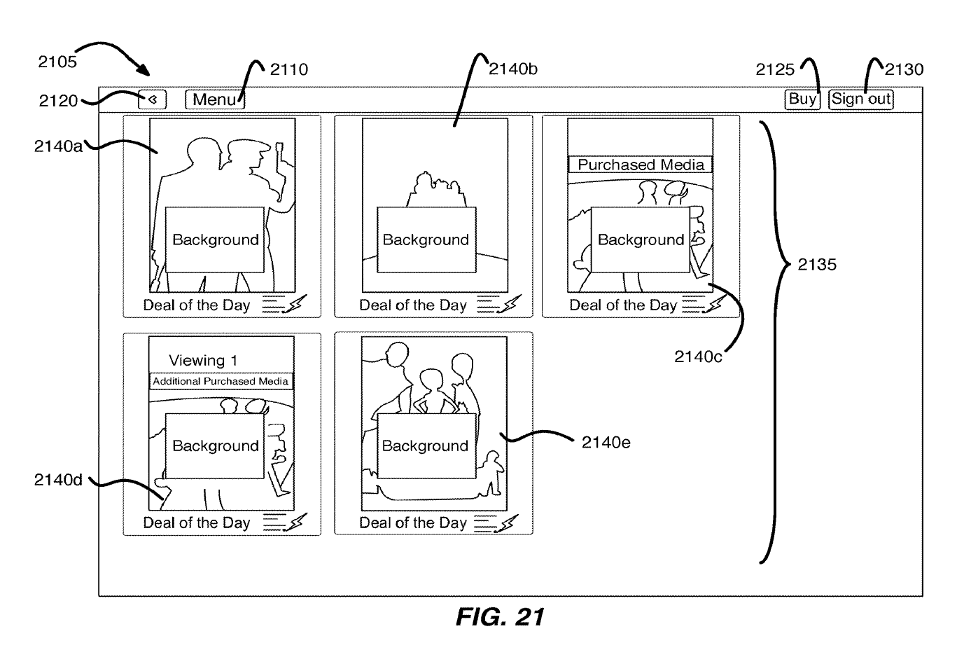

FIG. 21 is an exemplary screenshot of a GUI 2105 of a client device in a networked environment showing a screen initially displayed to a user after purchasing additional viewings of per-view and per-timeframe purchase, license, rental, distribution and consumption media content previously purchased by the user.

In FIG. 21, the media content options screenshot 2105 shows a tile display of the media content options the user will have. The user may be presented this Media Content Options screen 2105 when the user wishes to view one or more of media content available for purchase, license, rental, distribution and consumption, and media content previously purchased, licensed, rented, and distributed 2140c and 2140d prior to consumption. The Media Content Options menu 2110 comprises Back button 2120, Buy button 2125, Sign Out button 2130, and Media Content list 2135. The Back button 2120 takes the user back to one or more of a login page, a home page, or an other page. The Buy button 2125 takes the user to an Item Purchase screen as given in FIG. 20. The Sign Out button 2130 logs the user out from the application, then terminates the application.

The Media Content list 2135 comprises media content buttons 2140a-2140e. Media content buttons 2140a-2140e offer the user the opportunity to view different media content. In this particular example, the user is offered the opportunity to view a first motion picture using first media content button 2140a. In this particular example, the user is offered the opportunity to view a second motion picture using second media content button 2140b. In this particular example, the user is offered the opportunity to view a customized motion picture previously purchased using third media content button 2140c. In this particular example, the user is offered the opportunity to view additional viewings of the customized motion picture previously purchased using fourth media content button 2140d. In this particular example, the user is offered the opportunity to view a fifth motion picture using fifth media content button 2140e.

For example, a selection to view additional customized motion picture previously purchased by a user may be performed by pressing fourth media content button 2140d from the Media Content list 2135. For example, a selection to view a customized motion picture previously purchased by a user may be performed by pressing one or more of the third media content button 2140c and fourth media content button 2140d from the Media Content list 2135. The user is then taken to Viewing Confirmation screen 1710 in FIG. 17.

FIG. 22 is an exemplary screenshot of a GUI 2205 of a client device in a networked environment that displays an example of how the GUI receives a selection of customization preferences of the user for per-viewing and per-timeframe purchase, license, rental, distribution and consumption of one or more of media content and product merchandise.

Customized Preference screen 2205 comprises Username field 2210, Password field 2215, Media Content Rating slider 2220, Interval Viewable From slider 2225, Interval Viewable To slider 2230, Create Sub-Account button 2235, and Done button 2240. Username field 2210 receives a user's username of the account to which customized preferences are to be ascribed. Password field 2215 receives a user's password of the account the sub-account to which customized preferences are to be ascribed. Media Content Rating slider 2220 allows a user to select one or more of a minimum and maximum media rating content. Interval Viewable From slider 2225 allows a user to select a beginning day interval 2245 and beginning time interval 2250 by which media content will be available for viewing by the user. Interval Viewable To slider 2230 allows a user to select an ending day interval 2255 and ending time interval 2260 by which media content will no longer be available for viewing by the user. After a user's username and password have been received, a sub-account may be created by pressing Create Sub-Account button 2235. The user is then taken to a Sub-Account Preference screen (not pictured.)

Variations are almost unlimited, as will be evident to those of skill in the art. For example, Customized Preference screen 2205 could further comprise sliders allowing the user to provide input on one or more of the media's genre, duration, language, or an other input.

When the user has finished selecting the customized preferences, the user presses a Done button 2240.

While the above representative embodiments have been described with certain components in exemplary configurations, it will be understood by one of ordinary skill in the art that other representative embodiments can be implemented using one or more of different configurations and different components. For example, it will be understood by one of ordinary skill in the art that the order of certain fabrication steps and certain components can be altered without substantially impairing the functioning of the invention.

For example, one or more of audio, video, and another entertainment format can be playing on the client-side. For example, one of more of audio, video, and another entertainment format can be played on the server-side.

For example, while this application for simplicity at times verifies that the media to be one or more of a per-viewing and per-timeframe purchase, license, rental, distribution and consumption is a motion picture, embodiments of the invention are also applicable to silent pictures, video recordings of concerts, audio recordings of concerts, video recordings of interviews, audio recordings of interviews, and countless other media. For example, instead of being implemented by the client-side electronic commerce application 140 and the server-side electronic commerce application 186, the server-side tracking application 188, the server-side data search application 192, the server-side transmission application 194, and the server-side streaming application 195 in the steps of the flowcharts depicted in FIG. 3 through FIG. 14 may be implemented by one or more of the server-side computing device 170 and the client-side device 120.

For example, instead of being located in the client-side memory 130 the client-side electronic commerce application 140 may be located in a section of the client device 120 other than the client-side memory 130

For example, instead of being located in the server-side memory 180, one or more of the server-side electronic commerce application 186, the server-side tracking application 188, the server-side data search application 192, the server-side transmission application 194, and the server-side streaming application 195 may be located in a section of the server-side computing device device 170 other than the server-side memory 180. For example, instead of being located in the server-side computing device 170, the server-side memory 180 may be a free-standing component of the server-side networked environment 110.

For example, the client-side data storage 135 may be separate from the client device 120 rather than being comprised in the client device 120. For example, the server-side data storage 165 may be comprised in the server-side computing device 170 rather than being separate from the server-side computing device 170.

For example, instead of being separated from server-side data storage 165, the first data storage 108 and second data storage 109 may be located in the server-side data storage 165.

For example, instead of being the client device 120 and the client-side playback device 125 being two separate entities, the client-side playback device 125 may be comprised in the client device 120. For example, instead of the server-side electronic commerce application 186 and the server-side tracking application 188 being two separate entities, the server-side tracking application 188 may be comprised in the server-side electronic commerce application 186. For example, instead of the server-side electronic commerce application 186 and the server-side tracking application 188 being two separate entities, the server-side electronic commerce application 186 may be comprised in the server-side tracking application 188.

For example, in addition to the Media Content buttons seen in FIG. 15, one could also have a Deal Of The Day button, a Community button, a Gaming button, and the like. For example, the media content offered to the user may be any number of one or more of media content and product merchandise.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

What is claimed is:

1. A method for per-viewing and per timeframe purchase, license, rental, distribution and consumption of media content and product merchandise, comprising:
obtaining and processing, by a client device under a user's control, a user's username and password by the user;
creating and transmitting, by the client device, to the server-side computing device, a client-side message or packet comprising one or more of user's username and password to the server-side computing device;
receiving and processing, by the client device, a server-side message or packet comprising one or more of user's unique identifier, customization preferences of the user, media content unique identifier, media images URLs, media content URLs, and sub-account preferences of the user for media content to be played on the client device in coordination with the server-side computing device;
obtaining and processing, by the client device, a command to display media content by the user;
creating and transmitting, by the client device, to the server-side computing device, a client-side message or packet comprising one or more user's unique identifier and media content unique identifier of the media content selected by the user;
receiving and processing, by the client device, a server-side message or packet comprising one or more of user's unique identifier, customization preferences of the user, media content unique identifier, media images URLs, media content URLs, per-viewing identifier, per-timeframe identifier, and sub-account preferences of the user of the media content selected by the user; and
creating and displaying, by the client device, display tile images using the media content unique identifier for the client-side playback of the media content selected by the user.

2. The method of claim 1, wherein the step of communicating comprises transmitting a client-side message or packet, by the client device, over the network, to the server-side computing device.

3. The method of claim 1, wherein the step of obtaining comprises receiving a command to display per-viewing and per-timeframe media content by the user;

4. The method of claim 1, wherein the step of creating and displaying display tile images for the user comprised in one or more of client-side data storage and client-side memory.

5. The method of claim 1, comprising a further step, performed after the substantially displaying step, of:
relaying to the user, by the client device, one or more offers to purchase product merchandise by the server-side computing device using the media content unique identifier.

6. A method for per-viewing and per timeframe purchase, license, rental, distribution and consumption of media content and product merchandise, comprising:
receiving and processing, by a server-side computing device, from a client device under a user's control, a client-side message or packet from the client device comprising one or more of a user's username and password;
creating, by the server-side computing device, a server-side message or packet comprising one or more of a user's unique identifier, customization preferences of the user, media content unique identifier, media images URLs, media content URLs, and sub-account preferences of the user;
transmitting, by the server-side computing device, to the client device, the server-side message or packet comprising one or more of user's unique identifier, customization preferences of the user, media content unique identifier, media images URLs, media content URLs, and sub-account preferences of the user;
receiving and processing, by the server-side computing device, a client-side message or packet comprising one or more of user's unique identifier and media content unique identifier;
processing, by the server-side computing device, records comprised in one or more of first data storage, second data storage, server-side data storage and server-side memory, so as to create per-viewing time allowance and per-timeframe allowance of media content; and
generating and transmitting, to the client device, the server-side message or packet comprising one or more of user's unique identifier, customization preferences of the user, media content unique identifier, media images URLs, media content URLs, per-viewing identifier, per-timeframe identifier, and sub-account preferences of the user.

7. The method of claim 6, wherein the step of communicating comprises transmitting a server-side message or packet, by the server-computing device, over the network, to the client-side computing device.

8. The method of claim 6, wherein the step of creating comprises generating one or more of a user's unique identifier, customization preferences of the user, media content unique identifier, media images URLs, media content URLs, and sub-account preferences of the user using characteristics comprised in one or more of the first data storage, second data storage, server-side data storage and server-side memory.

9. The method of claim 6, wherein the step of processing records comprised in one or more of the first data storage, second data storage, server-side data storage, and server-side memory generates per-viewing allowance and per-timeframe allowance.

10. The method of claim 6, wherein the step of generating and transmitting to the client device the server-side message or packet comprising one or more of user's unique identifier, customization preferences of the user, media content unique identifier, media images URLs, media content URLs, per-viewing identifier, per-timeframe identifier, and sub-account preferences of the user.

11. A method for viewing per-viewing and per timeframe purchase, license, rental, distribution and consumption of media content and product merchandise, comprising:
obtaining and processing, by a client device under a user's control, a selection for viewing media content by the user;
displaying and processing, by the client device, a confirmation prompt of the selection for viewing media content;
generating and transmitting, by the client device, to a server-side computing device, a client-side message or packet comprising one or more of user's unique identifier and selected viewing identifier;
receiving and processing, by the client device, a server-side message or packet comprising one or more of user's unique identifier, selected viewing identifier, customization preferences of the user, media content unique identifier, media image URLs, media image URLs, per-viewing identifier, per-timeframe identifier, and sub-account preferences of the user; and
obtaining and processing, by the client device, a command to commence playback of the media content by the user.

12. The method of claim 11, wherein the step of obtaining comprises receiving a command to display per-viewing and per-timeframe media content by the user.

13. The method of claim 11, wherein the step of generating and transmitting, by a client device, to a server-side computing device, a client-side message or packet comprising one or more of user's unique identifier and selected viewing identifier.

14. The method of claim 11, wherein the step of receiving and processing, by a client device, a server-side message or packet comprising one or more of user's unique identifier, selected viewing identifier, customization preferences of the user, media content unique identifier, media image URLs, media image URLs, per-viewing identifier, per-timeframe identifier, and sub-account preferences of the user.

15. The method of claim 11, wherein the step of obtaining and processing, by a client device, comprises receiving a command to commence playback of the media content.

16. A method for viewing per-viewing and per timeframe purchase, license, rental, distribution and consumption of media content and product merchandise, comprising:
receiving and processing, by a server-side computing device, from a client device under a user's control, a client-side message or packet comprising one or more of user's unique identifier and selected viewing identifier;
processing, by the server-side computing device, records comprised in one or more of first data storage, second data storage, server-side data storage, and server-side memory, so as to create per-viewing allowance and per time-frame allowance of the media content;
generating and transmitting, to the client device, a server-side message or packet comprising one or more of user's unique identifier, selected viewing identifier, customization preferences of the user, media content unique identifier, media image URLs, media image URLs, per-viewing identifier, per-timeframe identifier, and sub-account preferences of the user; and
processing, by the server-side computing device, records comprised in one or more of the first data storage, second data storage, server-side data storage, and server-side memory, so as to reduce the per-viewing allowance by a pre-determined amount of viewings.

17. The method of claim 16, wherein the step of generating and transmitting, to the client device, a server-side message or packet comprising one or more of user's unique identifier, selected viewing identifier, customization preferences of the user, media content unique identifier, media image URLs, media image URLs, per-viewing identifier, per-timeframe identifier, and sub-account preferences of the user.

18. The method of claim 16, wherein the step of processing, by the server-side computing device, records comprised in one or more of the first data storage, second data storage, server-side data storage, and server-side memory, so as to reduce the per-viewing allowance by a pre-determined amount of viewings.

19. A method for transacting per-viewing and per timeframe purchase, license, rental, distribution and consumption of media content and product merchandise, comprising:
obtaining and processing, by a client device under a user's control, a user's username and password by the user;
generating and transmitting, by the client device, to a server-side computing device, a client-side message or packet comprising one or more of user's username and password;
receiving and processing, by the client device, a server-side message or packet comprising one or more of user's unique identifier and an other unique identifier;
obtaining and processing, by the client device, one or more of user's order and user's billing information by the user;
generating and transmitting, by the client device, to the server-side computing device, a client-side message or packet comprising one or more of user's unique identifier, user's order, and user's billing information;
receiving and processing, by the client device, a server-side message or packet comprising one or more order completion information and order completion notification; and
creating and displaying, by the client device, one or more order completion confirmation and order completion notification.

20. A method for transacting per-viewing and per timeframe purchase, license, rental, distribution and consumption of media content and product merchandise, comprising:
receiving and processing, by a server-side computing device, from a client device under a user's control, a client-side message or packet comprising one or more of user's username and password by the user;
generating and transmitting, by the server-side computing device, to a client device, a server-side message or packet comprising one or more of user's unique identifier and an other unique identifier;
receiving and processing, by the server-side computing device, a client-side message or packet comprising one or more of user's unique identifier, user's order, and user's billing information;
transmitting, verifying and transacting, by the server-side computing device, the user's order and user's billing information with one or more of external server and internal server so as to receive payment transaction information and payment authorization information;
creating, by the server-side computing device, segmented media content;
creating, by the server-side computing device, one or more of a media content playlist and a unique playlist reference link;
creating and uploading, a server-side message or packet comprising one or more of segmented media content, media content playlist, and unique playlist reference link to one or more of first data storage, second data storage, server-side data storage, and server-side memory;
creating and uploading, a server-side message or packet comprising one or more records to one or more of first data storage, second data storage, server-side data storage, and server-side memory; and
generating and transmitting, by the server-side computing device, to the client device, a server-side message or packet comprising one or more order completion information and order completion notification.

21. A method for transacting sub-account per-viewing and per timeframe purchase, license, rental, distribution and consumption of media content and product merchandise, comprising:
obtaining and processing, by a client device under a user's control, one or more of a sub-account and sub-account preferences by the user;
receiving and processing, by a client device, from a server-side computing device, a server-side message or packet comprising one or more of user's unique identifier and an other identifier;
obtaining and processing, by a client device, one or more of a sub-account order and user's billing information by the user;
generating and transmitting, by the client device, to the server-side computing device, a client-side message or packet comprising one or more of user's unique identifier, sub-account order, and user's billing information;
receiving and processing, by the client device, from the server-side computing device, a server-side message or packet comprising one or more order completion information and order completion notification; and
creating and displaying, by the client device, one or more order completion confirmation and order completion notification.

22. A method for transacting sub-account per-viewing and per timeframe purchase, license, rental, distribution and consumption of media content and product merchandise, comprising:
receiving and processing, by a server-side computing device, from a client device under a user's control, a client-side message or packet comprising one or more of sub-account and sub-account preferences;
generating and transmitting, by a server-side computing device, to a client device, a server-side message or packet comprising one or more of user's unique identifier and an other unique identifier;
receiving and processing, by the server-side computing device, from the client device, a client-side message or packet comprising one or more of user's unique identifier, sub-account order, and user's billing information;
transmitting, verifying and transacting, by the server-side computing device, the sub-account order and user's billing information with one or more of external server and internal server so as to receive payment transaction information and payment authorization information;
creating, by the server-side computing device, segmented media content;
creating, by the server-side computing device, one or more of a media content playlist and a unique playlist reference link;
creating and uploading, by the server-side computing device, a server-side message or packet comprising one or more of segmented media content, media content playlist, and unique playlist reference link to one or more of first data storage, second data storage, server-side data storage, and server-side memory;
creating and uploading, by the server-side computing device, a server-side message or packet comprising one or more records to one or more of first data storage, second data storage, server-side data storage, and server-side memory; and
generating and transmitting, by the server-side computing device, to the client device, a server-side message or packet comprising one or more order completion information and order completion notification.

23. A method for uploading provider content for per-viewing and per timeframe purchase, license, rental, distribution and consumption of media content and product merchandise, comprising:
obtaining and processing, by a client device under a user's control, a media content provider's username and password by the media content provider;
generating and transmitting, by the client device, to a server-side computing device, a client-side message or packet comprising one or more of media content provider's username and password;
obtaining and processing, by a client device, one or more of media content and media content database by the media content provider;
generating and transmitting, by the client device, to a server-side computing device, a client-side message or packet comprising one or more of media content, media content provider's unique identifier, and media content database; and
receiving and processing, by a client device, from the server-side computing device, a server-side message or packet comprising one or more of upload completion confirmation and upload completion notification.

24. A method for uploading provider content for per-viewing and per timeframe purchase, license, rental, distribution and consumption of media content and product merchandise, comprising:
receiving and processing, by a server-side computing device, from a client device under a user's control, a client-side message or packet comprising one or more of media content provider's username and password;
generating and transmitting, by a server-side computing device, to a client device, a server-side message or packet comprising one or more of media content provider's unique identifier and an other unique identifier;
receiving and processing, by the server-side computing device, from the client device, a client-side message or packet comprising one or more of media content, media content provider's unique identifier, and media content database;
creating, by the server-side computing device, segmented media content;
creating, by the server-side computing device, one or more of a media content playlist and a unique playlist reference link;
creating and uploading, by the server-side computing device, a server-side message or packet comprising one or more of segmented media content, media content playlist, and unique playlist reference link to one or more of first data storage, second data storage, server-side data storage, and server-side memory;
creating and uploading, by the server-side computing device, a server-side message or packet comprising one or more of media content database to one or more of first data storage, second data storage, server-side data storage, and server-side memory; and
generating and transmitting, by the server-side computing device, to the client device, a server-side message or packet comprising one or more upload completion information and upload completion notification.

25. A method for uploading provider content for authenticating per-viewing and per timeframe purchase, license, rental, distribution and consumption of media content and product merchandise, comprising:
obtaining and processing, by a client device under a user's control, a user's username and password by the user;
creating and transmitting, by the client device, to the server-side computing device, a client-side message or packet comprising one or more of user's username and password to the server-side computing device; and
receiving and processing, by the client device, from a server-side computing device, a server-side message or packet comprising one or more of user's unique identifier and an other unique identifier.

26. A method for uploading provider content for authenticating per-viewing and per timeframe purchase, license, rental, distribution and consumption of media content and product merchandise, comprising:
receiving and processing, by a server-side computing device, from a client device under a user's control, a client-side message or packet comprising one or more of a user's username and password; and
generating and transmitting, by the server-side computing device, to the client device, the server-side message or packet comprising one or more of user's unique identifier and an other unique identifier.

27. A server-side computing device for customizing media content, comprising:
a processor;
data storage operably connected with the processor;
memory operably connected with the processor, the memory comprising one or more of a server-side electronic commerce application, a server-side tracking application, a server-side data search application, a server-side transmission application, and a server-side streaming application;
a playback device operably connected with the processor; and
a local interface operably connected with the processor and configured to communicate over a network with a client device under a user's control,
the server-side electronic commerce application configured to receive over the network from the client device a message or packet comprising per-viewing and per-timeframe media content and product merchandise,
the server-side tracking application configured to query and process over the network particular search parameters in data storage and memory to verify the availability of per-viewing and per-timeframe media content selected by the user,
the server-side data search application configured to query and process over the network one or more of records in data storage and memory to correspond with particular search parameters and initiate the access of per-viewing and per-timeframe media content selected by the user,
the server-side transmission application configured to transmit over the network a message or packet to one or more of an external server and an internal server so as to one or more verify and transact the user's order and billing information,
the server-side streaming application configured to segment media content for deployment via the network to the client device,
the local interface configured to transmit to the client device via the network server-side timing information and the per-viewing and per-timeframe media content and product merchandise so that the client device may substantially synchronize with its playback of the per-viewing and per-timeframe media content and product merchandise by the playback device.
